(19) United States
(12) Patent Application Publication
(10) Pub. No.: US 2012/0143738 A1
(43) Pub. Date: Jun. 7, 2012

(54) PUBLIC MARKETS FOR ECONOMIC INDICATORS

(75) Inventor: Andrew McConnel, North Sydney, NSW (AU)

(73) Assignee: ACN 123 157 399 PTY LTD, North Sydney, NSW (AU)

(21) Appl. No.: 12/520,632

(22) PCT Filed: Dec. 21, 2007
(86) PCT No.: PCT/AU07/01989

§ 371 Date: Dec. 10, 2009

(30) Foreign Application Priority Data
Dec. 22, 2006 (AU) 2006907143
Mar. 8, 2007 (AU) 2007901180
Dec. 20, 2007 (AU) 2007907107

(51) Int. Cl. G06Q 40/00

(52) U.S. Cl. 705/35

(57) ABSTRACT

The present invention relates to a financial instrument, system and method that enables public trading in spot and forward markets of any Index, and in particular to spot and forward markets for the trading of a Price Index on a Recognized Exchange or Exchanges, using the financial instrument as “good delivery”, without having to create and list managed index funds that invest in the underlying security comprising the subject Index. The invention has been developed primarily for use as a means for creating spot and forward markets for trading of a Price Index on a Recognized Exchange and will be described hereinafter with reference to this application. However, it will be appreciated that the invention is not restricted to this particular field of use.

The present invention relates to a financial instrument, system and method that enables public trading in spot and derivative markets of any index, and in particular to spot and derivative markets for the trading of an Price Index on a Recognised Exchange or Exchanges, using the financial instrument as “good delivery”, without having to create and list managed index funds that invest in the underlying security comprising the subject Index.

The invention has been developed primarily for use as a means for creating spot and derivative (such as futures and options) markets for trading of a Price Index on a Recognised Exchange and will be described hereinafter with reference to this application. However, it will be appreciated that the invention is not restricted to this particular field of use.

### COPYRIGHT NOTICE

This document is subject to copyright. The reproduction of this document in Patent Office records and communications is permitted; however, alt other copyright rights are reserved.

### PROBLEMS OF THE PRIOR ART

There presently exist a number of futures and options (forwards) markets based on internationally recognised Price Indices for which there are no “spot” or “cash” markets. Examples include cash-settled commodity futures contracts claimed by the Chicago Board of Trade in US Patent Application Publication No. US 2005/0154660 A1, capital markets index and futures contracts claimed by the Board of Trade of the City of Chicago in US Patent Application Publication No. US 20040236661 A1, municipal note index future claimed by the Chicago Board of Trade in US Patent Application Publication No. US 2004/0199451 A1. None of these above-named patent applications include cash settled Spot Markets linked to the underlying security's Price Index. Spot Markets are essential to the price discovery process and dynamics of forward markets.

Without a publicly accessible Spot Market, traders have no price reference on which to base their bids and offers for forwards contracts. Consequently there is no mathematical or dynamic relationship between the calculated value of the Price Index at a specific time and the prices quoted for index forward markets until their maturity (or delivery) date. This can result in a disconnect or price distortion between the value of forwards contracts relating to trades in a particular security and the relevant Price Index for that security.

In the case of some Price Index-based forward markets (particularly share market indices) listed unit trusts have been introduced as a “de facto” spot market for the subject Price Index. Listed unit trusts invest in the underlying assets/components of a Price Index in exactly the same quantities/ratios as the Price Index. An example is the S&P 500 Depository Receipts (SPDRs, also known as “Spiders and Diamond”), which is a basket of securities traded on an exchange. These securities are held by a trust with the objective that the value of the securities will track the performance of the S&P 500 Index. This process has the following disadvantages:
(a) It is either logistically impossible and/or prohibitively expensive to invest in and hold/store the components of most economic performance indicators and indices based on commodities, housing, financial markets, and a number of other measures of collective market price activity;
(b) If a unit trust structure is used, it favours the manager of that trust only. This is because no other Investment institutions can participate in the de facto “spot” market as originators; and
(c) Units in the unit trust cannot be used as “good delivery” to forward markets. “Good delivery” is the delivery of the security traded in proper form for transfer of title to the buyer. A transaction cannot be settled without good delivery.

Another example of index-based trading is forwards trading in the S&P/Case-Shiller index. This is an index of residential property pricing in major USA cities. The futures contracts traded are the Chicago Mercantile Exchange (CME) housing contracts, which are valued at $250 times the current index value. For example, if the current value of the S&P/Case-Shiller Home index is 98.50, the value of that futures contract is $250×98.50=$24,625. CME housing futures prices change continuously, resulting in a customer holding a CME Housing futures contract encountering either gains or losses, based on the original price at which the customer bought or sold the contract. By quantifying the economic risk of shifts in housing index prices, a customer can hedge housing-price-related risk or take advantage of housing price fluctuations. The disadvantage of forwards trading in CME housing contracts is the absence of a Spot Market for the underlying security.

Further, only a small number of Price Indices are traded in publicly accessible markets. There are a number of important indices and economic indicators that are not being traded or are only traded in “off market” transactions. Techniques developed for the “off market” trading of “contracts for differences” based on Price Indices have disadvantages, including:
(a) In many cases the contracts are not “fungible” (interchangeable);
(b) Parties to the contracts cannot be novated; and
(c) Parties do not have the ability to directly hedge or offset price fluctuations in the underlying security.

As a consequence of the lack of fungibility and the inability to be novated, “off market” trading of “contracts for differences” is not afforded public trading transparency in accordance with the requirements of government market regulators such as The Securities Exchange Commission (in the United States) and The Australian Securities and Investment Commission. This is probably the most important factor in encouraging public participation in “Recognised Exchange” markets.

The extraordinary increase of trading volumes in listed index-based funds (or exchange traded funds) such as the “Kospi 200” in Korea and “Spiders and Diamonds” in the United States indicates strong consumer demand for index-based trading on Recognised Exchanges. Known products, systems and methods for such index-based trading are complex, expensive and suffer other disadvantages as outlined above. Key deficiencies in known products, systems and methods are:
(i) the absence of a Spot Market for indices; and
(ii) the lack of a simple financial instrument for effecting index-based trading in the spot and futures markets.

Recognition of these deficiencies has prompted the creation of SMPICs as an instrument for conducting index-based trading on Recognised Exchanges. The existence of such an instrument enables the listing of any index on a Recognised Exchange and the creation of spot and forward markets for trading such indices.

### OBJECT OF THE INVENTION

It is an object of the present invention to overcome or ameliorate at least one of the disadvantages of the prior art, or to provide a useful alternative.

According to one aspect of the invention there is provided a financial mechanism to enable creation of a spot market for trading of one or more indices on a Recognised Exchange including:
(a) a fungible instrument defined as a Spot Market Price Index Contract (SMPIC); and
(b) listing of said SMPIC in said spot market on at least one Recognised Exchange.

According to another aspect of the present invention there is provided a financial mechanism for listing an index on a Recognised Exchange for spot market trading, wherein said index may be one of the following, without limitation:
a) a consumer price index;
b) a producer price index;
c) a primary production price index;
d) a manufacturing price index;
e) a currency index;
f) a housing price index;
g) a commodity price index such as an index for:
   (i) energy;
   (ii) a foodstuff;
   (iii) a metal;
   (iv) a mineral;
   (v) a textile;
   (vi) livestock;
   (vii) water;
h) a weather index;
i) an interest rates index
j) a carbon index; or
k) any other economic indicator.

According to yet another aspect of the invention there is provided a financial mechanism for listing an index on a Recognised Exchange for derivative market trading, wherein said index may be one of the following, without limitation:
a) a consumer price index;
b) a producer price index;
c) a primary production price index;
d) a manufacturing price index;
e) a currency index;
f) a housing price index;
g) a commodity price index such as an index for:
   (i) energy;
   (ii) a foodstuff;
   (iii) a metal;
   (iv) a mineral;
   (v) a textile;
   (vi) livestock;
   (vii) water;
h) a weather index;
i) an interest rates index
j) a carbon index; or
k) any other economic indicator.

According to yet another aspect of the invention there is provided a system to enable creation of a spot market for trading of one or more indices on a Recognised Exchange including:
(c) a fungible instrument defined as a Spot Market Price Index Contract (SMPIC); and
(d) means for listing of said SMPIC in said spot market on at least one Recognised Exchange.

According to still another aspect of the invention there is provided a system for listing an index on a Recognised Exchange for spot market trading, wherein said Index may be one of the following, without limitation:
a) a consumer price index;
b) a producer price index;
c) a primary production price index;
d) a manufacturing price index;
e) a currency index;
f) a housing price index;
g) a commodity price index such as an index for:
   (i) energy;
   (ii) a foodstuff;
   (iii) a metal;
   (iv) a mineral;
   (v) a textile;
   (vi) livestock;
   (vii) water;
h) a weather index;
i) an interest rates index
j) a carbon index; or
k) any other economic indicator.

According to yet still another aspect of the invention there is provided a system for spot market trading of an index on a Recognised Exchange wherein said system includes:
(a) a fungible instrument defined as a Spot Market Price Index Contract (SMPIC);
(b) listing of said SMPIC for trading on a Recognised Exchange;
(c) software, hardware and one or more computer implemented systems including one or more processing arrangements for recording and administering a transaction involving said SMPIC;
(d) one or more said processing arrangements that interface(s) with a computer-implemented system of said Recognised Exchange;
(e) one or more said processing arrangements that interface(s) with a computer-implemented system of a Clearing House; and
(f) one or more said processing arrangements that enable data processing and storage including:
   i. matching and recording of a settlement price(s);
   ii. calculation and recording of a Redemption Value(s);
   iii. calculation of one or more fees payable in relation to one or more transactions;
   iv. calculation of a difference(s) between said settlement price(s) and an amount payable to a seller;
   v. calculation of a difference(s) between said settlement price(s) and an amount payable by a buyer;
   vi. calculation of a difference(s) between said Redemption Value(s) and an amount payable to a buyer;
   vii. calculation of a difference(s) between said Redemption Value(s) and an amount payable by a seller;
   viii. distribution of funds in accordance with said calculations; and
   ix. one or more databases containing details of each transaction, including details of said buyer and said seller.

According to yet still further another aspect of the invention there is provided a method to enable creation of a spot market for trading of one or more indices on a Recognised Exchange including the steps of:
(e) issue of a fungible instrument defined as a Spot Market Price Index Contract (SMPIC) for public trading; and
(f) listing of said SMPIC in said spot market on at least one Recognised Exchange.

According to yet another further aspect of the invention there is provided a method for spot market trading of an index on a Recognised Exchange, including the steps of:
(g) an Authorised Originator issuing a fungible instrument defined as a Spot Market Price Index Contract (SMPIC) for public trading;
(h) listing of said SMPIC for spot market trading on at least one Recognised Exchange; and
(i) trading of said SMPICs in said spot market on at least one Recognised Exchange.

According to yet another further aspect of the invention there is provided a method for listing an index for spot market trading on a Recognised Exchange, wherein said method includes the step of issuing a SMPIC for trading the value of an underlying index, wherein said index may be any of the following, without limitation:
a) a consumer price index;
b) a producer price index;
c) a primary production price index;
d) a manufacturing price index;
e) a currency index;
f) a housing price index;
g) a commodity price index such as an index for:
   (i) energy;
   (ii) a foodstuff;
   (iii) a metal;
   (iv) a mineral;
   (v) a textile;
   (vi) livestock;
   (vii) water;
h) a weather index;
i) an interest rates index
j) a carbon index; or
k) any other economic indicator.

According to another further aspect of the invention there is provided a method for spot market trading of an index on a Recognised Exchange, wherein said method includes the steps of implementing:
(a) issue of a SMPIC;
(b) listing of said SMPIC for trading on a Recognised Exchange;
(c) software, hardware and one or more computer implemented systems including one or more processing arrangements for recording and administering a transaction involving said SMPIC;
(d) one or more said processing arrangements that interface(s) with a computer-implemented system of said Recognised Exchange;
(e) one or more said processing arrangements that interface(s) with a computer-implemented system of a Clearing House; and
(f) one or more said processing arrangements that enable data processing and storage including:
   i. matching and recording of a settlement price(s);
   ii. calculation and recording of a Redemption Value(s);
   iii. calculation of one or more fees payable in relation to one or more transactions;
   iv. calculation of a difference(s) between said settlement price(s) and an amount payable to a seller;
   v. calculation of a difference(s) between said settlement price(s) and an amount payable by a buyer;
   vi. calculation of a difference(s) between said Redemption Value(s) and an amount payable to a buyer;
   vii. calculation of a difference(s) between said Redemption Value(s) and an amount payable by a seller;
   viii. distribution of funds in accordance with said calculations; and
   ix. one or more databases containing details of each transaction, including details of said buyer and said seller.

According to yet another further aspect of the invention there is provided a computer system to enable spot trading of a financial instrument on a Recognised Exchange, wherein said financial instrument is a SMPIC and said system includes:
a) one or more processors;
b) one or more databases; and
c) one or more computer terminals;
such that said trading of said SMPIC enables trading in the value of an underlying index.

According to another yet further aspect of the invention there is provided a computer system for trading of an index on a Recognised Exchange, including communication means between:
a) a Recognised Exchange, which provides and receives transactional data to and from a Clearing House along with data from:
   (i) a primary issue SMPIC trading database, which records detail of one or more SMPIC contracts available for public trading, including a current value of one or more relevant underlying indexes;
   (ii) a secondary trading in index-based derivatives database, which contains transactional data regarding:
      A. a buyer of SMPIC derivatives; and
      B. a seller of SMPIC derivatives;
      C. a current value of a relevant underlying index;
   (iii) a Spot Market SMPIC database, which contains transactional data regarding:
      i. a buyer of SMPIC on the Spot Market;
      ii. a seller of SMPIC on the Spot Market; and
      iii. a current value of a relevant underlying index;
b) said Clearing House, which records and provides SMPIC transactional data regarding:
   (i) a buyer of a SMPIC;
   (ii) a seller of a SMPIC;
   (iii) a buyer of a SMPIC option or futures contract;
   (iv) a seller of a SMPIC option or futures contract;
   (v) financial and other details (e.g. trade price, transaction date, settlement date, settlement value) of a trade;
c) an index Vendor (or a third party), which:
   (i) receives market data from a plurality of underlying physical market transactions;
   (ii) calculates, updates and publishes a current value of the index in accordance with regulations of said Recognised Exchange; and
   (iii) provides index data to said Recognised Exchange.

### BRIEF DESCRIPTION OF THE DRAWINGS

A preferred embodiment of the invention will now be described, by way of example only, with reference to the accompanying drawings in which:

FIG. 1 is a schematic diagram illustrating a carrying charge straddle;

FIG. 2 is a schematic diagram showing the broad framework for index-based trading on a Recognised Exchange;

FIG. 3 is a schematic diagram of a system for trading SMPICs on a Recognised Exchange; and

FIG. 4 is a schematic diagram illustrating a computer system for trading SMPICs on a Recognised Exchange.

### DETAILED DESCRIPTION

A preferred embodiment of the present invention will now be described by reference to the drawings. The following detailed description in conjunction with the figures provides the skilled addressee with an understanding of the invention. It will be appreciated, however, that the invention is not limited to the applications described below.

### Dictionary of Defined Terms

Table 1 is a dictionary of terms defined according to the invention. Terms defined in Table 1 are denoted with the use of capitalisation throughout the document. If a term is not capitalised then its plain meaning is to be construed, unless otherwise specified.

TABLE 1
Dictionary of defined terms

| Term | Description | |
|---|---|---|
| Authorised | The issuer of a SMPIC. Authorised Originators are those | |
| Originator | investment institutions who must be members of the Clearing | |
| | House and be authorised by the Recognised Exchange to issue | |
| | and sell SMPICs on the market. | |
| Clearing House | The organisation which undertakes to clear (including | |
| | registration, settlement of, and accounting for) SMPICs on | |
| | behalf of its Members and Members &/or clients of the | |
| | Recognised Exchange(s) it formally approves to conduct a | |
| | secondary market in SMPICs. | |
| Cover | Money and/or property held against a client's liability. Cover is | |
| | either cash or approved security lodged with the Clearing House | |
| | against fulfilment of contractual obligations and adverse | |
| | margins. The Clearing House will have, at its sole discretion, the | |
| | right to determine the amount, and call for immediate | |
| | lodgement, of cover from its Members with SMPICs open | |
| | positions. | |
| Deposit | (i) | In respect of a SMPIC opened by a Member Organisation |
| | | on its own account, the amount payable to the Clearing |
| | | House by the Member Organisation in respect of the |
| | | SMPIC; or |
| | (ii) | In respect of a SMPIC opened by a Member Organisation |
| | | on the instructions of a client, the amount payable by the |
| | | client to the Member Organisation in respect of the SMPIC. |
| Home Exchange | The Home Exchange of a Price Index is that Recognised | |
| | Exchange domiciled in the country of origin of the Price Index | |
| | and/or the Index Vendor. | |
| Index | Any quantifiable measure or indicator of change in a subject | |
| | area over time. The subject area could be a field of activity, | |
| | human endeavour, meteorological changes, economic/market | |
| | activity, or outlook (e.g. indicators of business confidence). The | |
| | Index reflects quantifiable movements of the value or measure | |
| | of its subject components. For example, a Price Index is any | |
| | single number calculated from an array of prices and quantities | |
| | over time. | |
| Index Vendor | The organisation that compiles and/or owns the rights in an | |
| | Index. | |
| Market Makers | Those Members of the Exchange and the Clearing House who | |
| | are authorised to buy and sell SMPICs on margin. | |
| Member | A member of a Clearing House and/or Exchange. | |
| Non-revisionary | An Index that is not subject to backward adjustments in value. | |
| Index | Trading in Non-revisionary Indices does not suffer the | |
| | disadvantages of trading in “revisionary” Indices (that is, Indices | |
| | that are revised backwards as a result of late data submission, | |
| | or new historical data or other reasons). These disadvantages | |
| | include the lack of index timeliness and potential historical | |
| | revisions in the underlying Index value delaying settlement until | |
| | after the release of the revised Index value. | |
| On Demand | Subject to notification by no later than a specified time on each | |
| | business day, holders (buyers) of SMPICs may, at their | |
| | discretion, request the Clearing House to pay the Redemption | |
| | Value against lodgement of their bought SMPICs for | |
| | cancellation. Redemption notifications may not be withdrawn. | |
| | Upon receipt of a demand for redemption, the Clearing House | |
| | will immediately notify the relevant sellers of the details of the | |
| | SMPICs lodged for redemption. Immediately subsequent to the | |
| | value of the subject Index being announced by the Index | |
| | Vendor, the Clearing House will calculate the value of the | |
| | SMPICs for redemption and will: | |
| | (i) | Notify and require sellers to pay the Redemption Value by |
| | | no later than a specified time on the business day following |
| | | the day of demand; and |
| | (ii) | Pay the Redemption Value to the requesting buyers whose |
| | | SMPICs documents have been lodged for cancellation. |

| | |
|---|---|
| Price Index | An indicator of economic/market activity. It reflects price |
| | movements of its subject components. A Price Index is any |
| | single number calculated from an array of prices and quantities |
| | over time. A representative sample may be used to calculate a |
| | Price Index. A Price Index is a subset of an Index. |
| Recognised | The platform or infrastructure for public trading, settling and |
| Exchange | clearing markets in financial instruments and/or derivatives |
| | governed by market regulations and rules which are recognised |
| | and approved by Government regulators such as ASIC in |
| | Australia and the SEC in the United States. |
| Redemption Value | The amount calculated by reference to the value of the subject |
| | Index announced by the Index Vendor at a specified time on |
| | each business day, or other time interval, as prescribed by the |
| | Recognised Exchange. |
| Spot (or Cash) | A market listed by a Recognised Exchange, in which buyers' and |
| Market | sellers' prices are publicly recorded and, when they match, |
| | result in a transaction for immediate delivery of the subject |
| | matter of the transaction from the seller to the buyer in return |
| | for prompt payment of the settlement value in cash. |
| Spot Market Price | A SMPIC is a fungible instrument publicly traded on a |
| Index Contract | Recognised Exchange. The seller of a SMPIC gives an |
| (SMPIC) | undertaking to pay the buyer the Redemption Value of the |
| | specified Index On Demand. SMPICs facilitate public “spot |
| | market” trading of Indices and give market participants access |
| | to the value of an Index. They do not give access to the |
| | underlying components of the subject Index. The parties to a |
| | SMPIC may be substituted by novation. |

The elements of the invention are now described under the following headings:

### Market Dynamics

Economic fluctuations occur in all sectors of the market and are a certainty. Market fluctuations are often seen as cyclical trends which may involve boom and bust extremes. Such market extremes have no relationship to non-extreme or “fundamental” market value. Property, shares and commodities are sectors of the market that regularly boom to the point, some say, that creates a sector bubble due to rapid, possibly speculative, increases in value which, by encouraging further speculation, leads to unsustainable market highs relative to what the market can afford.

### Derivative Markets

Derivatives enable investors to be exposed at a small cost to the price fluctuations of the underlying security and to hedge against adverse price movements. Hedging enables the risk from price movements in an asset purchase to be transferred to a derivative such as a futures contract or an option to purchase. Derivatives are traded on a Recognised Exchange as options and futures contracts.

Typically forward markets are based on trading in contracts wherein buyers and sellers agree to a price now for delivery of the subject matter of the deal at a specified time in the future.

The standard elements of forwards contracts are:
(i) A clear definition of the subject matter
   e.g. 100 troy ounces of 0.999 “fine” gold;
(ii) “Settlement time”: a time and date on which the contract matures and the subject matter must be delivered by the seller to the buyer in return for payment of the full value (consideration) of the contract at the price previously established between the buyer and the seller
   e.g. 100 ounces of gold at a traded price of $US350
   Settlement consideration=$US35,000 paid by the buyer to the seller against delivery of the gold bar; and
(iii) “Settlement place”: a point (place) at which the subject matter of the contract Is to be delivered for settlement, e.g. 100 Wall Street, New York. N.Y., United States of America.

Apart from normal economic factors, there is a monetary relationship between the spot price for an item (contract subject matter) and its forward price. There are costs incurred when buying, holding (storing) and ultimately delivering an item (carrying charges), for example:
(i) cost of purchase—the amount paid for the item (consideration);
(ii) cost of funding/opportunity cost—the interest amount, either payable or foregone, on the consideration for the time the item is held;
storage cost—cost of insuring and holding or storing the item; and
(iv) delivery (shipping) and settlement costs—the amount paid to insure and deliver the item to the settlement place.

Trading in futures contracts is one form of forward market. A futures contract works by trading a forwards contract to fix the price of an asset for one buyer and one seller.

A forwards contract can be bought in a selected asset, for example shares, gold, resources or other commodity. The forwards contract holder can then purchase or sell the selected asset whilst selling the futures contract in the same asset. The difference between opening and closing prices of the futures contract will be gained simultaneously to the price of the asset bought or sold. This enables the investor to move promptly to accept or protect against adverse price movements. This is an example of hedging (for other examples see the Australian Stock Exchange Limited's publications written by Andrew McConnel: Australian Financial Futures Market Pty Limited: Twenty Leaders index and The Australian Financial Futures Market).

Investors can also use forward markets to take advantage of expected price fluctuations of a short term or cyclical nature. For example, an investor buys a futures contract in a specified asset and then sells it after the anticipated price movement has taken place. The difference between opening and closing futures prices allows the investor to add to the value of the investment portfolio.

The buyer or seller of a futures contract is required to make only a small initial margin deposit. Since ownership of the underlying product is not actually transferred, the margin is not a down payment; it is essentially a security deposit to protect against non-performance of the contract. Since no credit is extended, no interest expense accrues on the non-margined value of the contract.

An exchange traded index option is a contract between two parties which gives the buyer (the taker) the right, but not the obligation, to require cash settlement for the value of the option position over a specified price (exercise price) of the relevant index on a predetermined date. The buyer may buy and sell this option before the predetermined date.

### Forward Markets Investment Strategies

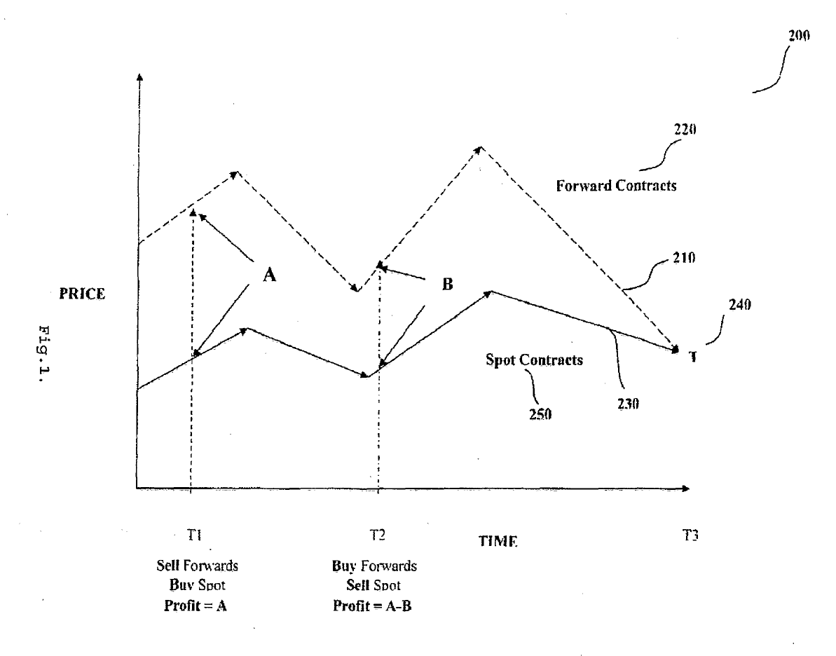

A “carrying charge straddle” is the simultaneous buying of a contract for delivery at one time and selling of a contract at another time, as illustrated schematically in FIG. 1. A “straddle” 200 is one of the means to control pricing or put parameters on pricing forwards.

The “forwards” line 210 indicates changes in forwards pricing over time. The subject of a forwards contract 220 can be any security. The “spot” line 230 indicates changes in spot pricing over time of the same security. The letter “T” indicates the termination 240 of the forwards contract 220, which takes place at time T3.

At time T1, the value of the forwards contract 220 is high and the spot price 230 for the same security is relatively low. The price differential between the value of the forwards contract 220 and the value of the spot contract 250 is marked “A”. By selling the forwards contract 220 and buying the spot contract 250 at time T1, a profit of value “A” can be made. If this position is held until time T3, when the forwards contracts terminates, the profit is locked in to be value “A”.

Meanwhile, before the termination date, at a time T2, the market presents an opportunity to:
(i) buy back the forwards contract 200 at a lower price than at which it was sold at T1; and
(ii) sell the spot contract 250 at approximately the same price at which it was purchased at T1.

The profit that can be made by the straddle 200 at time T2 is equal to “A” minus “B”, where “B” is the price differential between the forwards contract 220 and the spot contract 250 at time T2. The advantage is that the profit is realised at an earlier time than waiting for the termination date T3 of the forwards contract. If forwards contracts are held to termination (or maturity) there will be a commitment for buyers and sellers to settle the cash difference between the price at which the contract was traded and the settlement price. The settlement price is determined by reference to the price of the forwards contract's underlying security, which is usually the spot price at T3. Forwards contracts do not have to be held to maturity because it is possible for investors to liquidate at any other time. The object is to simultaneously buy one and sell the other to lock in profit at the earliest possible time.

A theoretical forward selling price can be calculated using the following information:

Consideration+funding cost+storage cost+delivery cost=theoretical forward cost

Add to the theoretical forward cost, a profit margin for a potential market participant, and a price at which that participant would be prepared to sell forward can be established.

For example: Buy spot gold and sell for delivery in 180 days (contract size 100 oz)

| | |
|---|---|
| Spot gold price | $US350 |
| Interest rate | 10% p.a. |
| Storage and delivery costs | $US10 per 100 ounce bar of gold per month |
| Required profit margin | 10% |
| Cost of gold (100 oz. @ $US350 per oz.) | $US35,000 |
| Interest (10% p. a. for 180 days) | $US1,750 |
| Storage & Delivery ($10 for 6 months) | $US60 |
| Profit Margin (10%) | $US3,500 |
| Total Carrying Cost | $US40,310 |
| Forward selling price per ounce | $US403.10 |

The potential market participant will monitor the spot and 180 day delivery gold market prices. If the participant can buy spot and sell 180 days forward for a difference of $37.35 per ounce, a profit of $3,500 can be locked in by buying spot (and taking delivery) and selling forward (and delivering in 180 days time).

Equally (using the same example) if forward prices are low relative to the spot market, an owner of gold may be able to save some, or all, of the carrying costs (interest, storage, insurance and shipping) by simultaneously selling and delivering gold to the spot market and buying in the forward market. This is known as a “negative (or reverse carrying charge) straddle” and a theoretical forward 180 day buying price can be calculated as follows:

| | |
|---|---|
| Cast or Gold (100 oz. @ $US350) | $US35,000 |
| Deduct Holding Charges | |
| Interest (10% p.a. for 180 days) | $US1,750 |
| Storage & Delivery ($US10 for 6 months) | $US60 |
| Total Deductions | $US1,810 |
| Nett Amount | $US33,190 |
| Forward 180 day buying price per ounce | $US331.90 |

That is to say if spot gold is trading at $US350, the above participant would be prepared to buy 180 day forward gold at $US331.90 and sell it at $US403.10.

### Influence of Spot Markets on the Pricing of Forwards

Market participants may be prepared to trade well inside these prices; however, the above bid and offer prices represent the extreme market price parameters which have the effect of ensuring a dynamic relationship between spot and forward prices.

The transactions in the above are known as “arbitrage” or “straddles” to lock in a profitable outcome for the trader undertaking them. Although a specific commodity has been used, it is important to note that the principles and methods will be the same for all indices which become the subject of SMPICs.

Forward markets based on indices without the existence of a Spot Market, have no price reference on which to calculate and establish profitable arbitrage trades into those forward markets. Without the potential for this type of trading, other than at maturity, there is no influence on forward market pricing which has any relevance to the current value of the subject index. That is to say there is a complete disconnect, or void, between the calculated value of an index at a given time and prices traded in their forwards. Put conversely Spot Markets have an important influence on the price discovery process in forward markets.

Since a futures contract is a commitment to perform, every position is marked to the market daily. Thus, once a contract is bought or sold, and the margin deposited, the profits and losses resulting from any change in the market value of the contract are credited and debited to the appropriate accounts at the close of each trading day. All profits in excess of the original margin requirement can be withdrawn at will. If the equity in the account—initial margin plus or minus the dollar value of market changes—falls below an established maintenance level, additional payments must be made to bring the account back up to the initial margin level.

### Known Means for Index-Based Trading

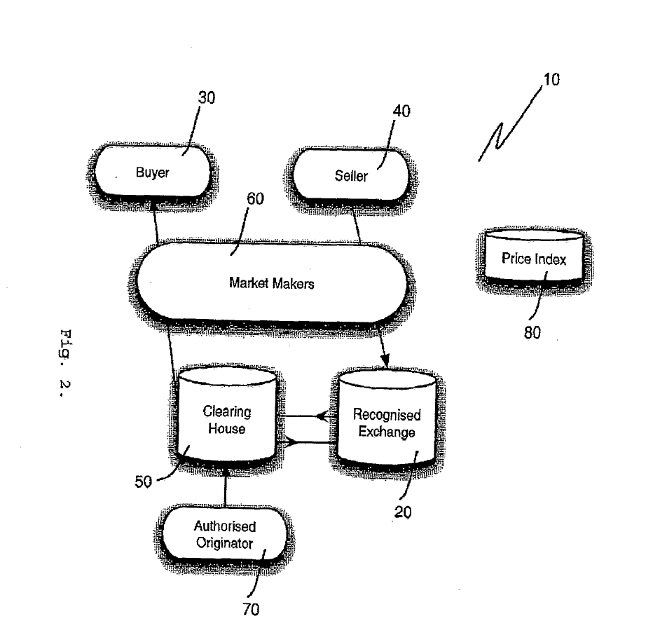

Previously known products, methods and systems for index-based trading suffer a number of disadvantages as set out in the “Problems of the prior art”. FIG. 2 schematically illustrates the procedures involved in known products, methods and systems for index-based trading on Recognised Exchanges.

The procedures 10 for previously known products, methods and systems have at their core:
(i) A Recognised Exchange 20, which is the trading platform that allows buyers 30 and sellers 40 access to markets;
(ii) A Clearing House 50, which performs a regulatory function between buyers 30 and sellers 40; and
(iii) Members of the Clearing House 50 and the Recognised Exchange 20.

Around the core are:
(i) Market Makers 60 or arbitrageurs, who perform broking functions; and
(ii) Authorised Originators 70, who are the original sellers to the market.

Authorised Originators 70 issue securities to the market, which are listed for trade on a Recognised Exchange 20. Buyers 30 and sellers 40 who wish to trade the relevant securities must do so through Market Makers 60. The trade is registered, settled and accounted for by the Clearing House 50 and publicly recorded on the Recognised Exchange 20. Where trades involve forwards contracts in index-based securities; there is currently no means for market price convergence with the current calculated value of the underlying Price Index 80. This can result in a disconnect or price distortion between the value of forwards contracts relating to trades in a particular security and the relevant Price Index 80 for that security.

### A Preferred Embodiment: SMPIC Trading

A Spot Market Price Index Contract (SMPIC) is a multi-originator single instrument for publicly listing and trading a Price index and in particular a Non-Revisionary Index.

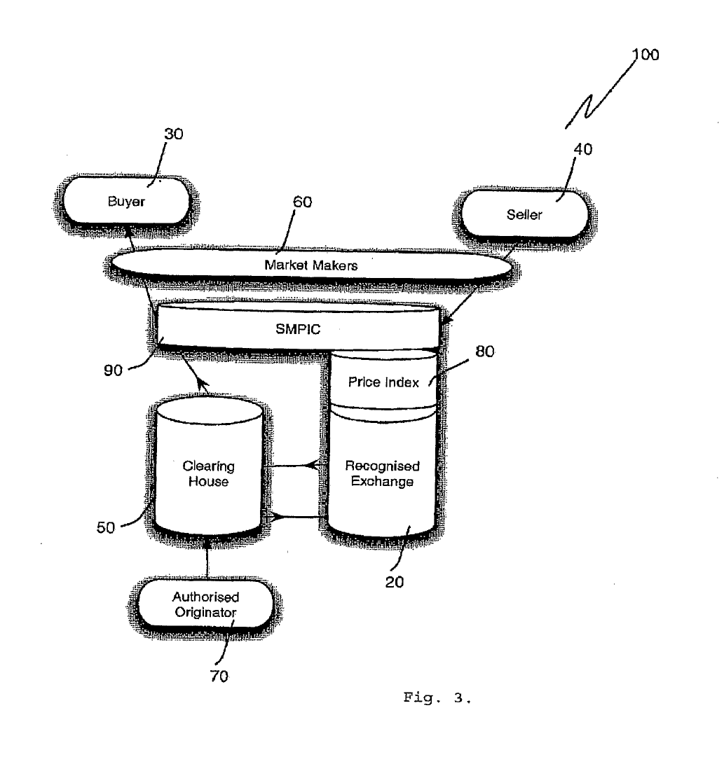

FIG. 3 schematically illustrates a system for index-based trading on a Recognised Exchange according to the invention. The invention provides a fungible instrument (a SMPIC 90) that enables both primary issue and secondary trading in index-based derivatives without having to create and list managed index-based funds. In this way, SMPICs 90 facilitate the uncomplicated and low cost introduction of a series of Spot Markets based on one or more Price Indices 80 together with their associated derivative markets. SMPICs 90 are the instrument for effecting financial arrangements between buyers and sellers and far trading the value of indices on Recognised Exchanges 20.

The invention provides a system and method for trading SMPICs 90 on Recognised Exchanges 20 in the same manner and under similar trading regulations to spot or cash markets (such as shares). However, Authorised Originators 70, who receive the cash proceeds for their sold positions, are “marked to market” and required to lodge acceptable security to cover their contractual obligations and adverse margins.

The price at which SMPICs 90 are traded shall be the amount of the Price Index 80, agreed between buyer 30 and seller 40, in accordance with the regulations of the Recognised Exchange 20 where the transaction takes place, expressed in the currency of the Home Exchange. A price so agreed shall be the amount used to determine the value for settlement between the parties to the transaction.

A buyer 30 of a SMPIC 90, other than a Market Maker 60, will pay full settlement value of the SMPIC 90 on the business day following the transaction date. A buyer 30 of a SMPIC 90 can then elect to hold the SMPIC, sell it in the market (on the Recognised Exchange 20) or present the SMPIC back to the seller 40 (via the Clearing House 50) for redemption.

Buyers 30 who elect to sell SMPICs 90 in the market surrender their SMPICs 90 for cancellation and will receive the settlement value of their sold SMPICs 90. The Clearing House 50 will maintain a register of all SMPICs bought and paid for in full. The register will detail the buyer's (owner's) name, address and other identification required at law. The Clearing House 50 may substitute the names of parties to a SMPIC 90 by novation.

Sellers 40 of SMPICs 90, other than Authorised Originators 70 and buyers 30 who sell their bought SMPICs 90, will NOT receive settlement value and will be required to lodge cover with the Clearing House 50 against fulfilment of their obligations. The Clearing House 50 will mark all open sold positions to market and will demand cover for adverse margins.

Authorised Originators 70 of SMPICs 90 which have first been Issued, lodged with and endorsed by the Clearing House 50 and are subsequently sold, will be entitled to receive full settlement value of such SMPICs 90, calculated at the traded price, less an amount which will be held by the Clearing House 50, to the account of the Authorised Originator 70, as a security deposit to cover the Authorised Originator's obligations to perform in accordance with regulations. All other sellers of SMPICs 90, such as private investors, shall have first bought SMPICs 90 in the market and will be entitled to payment of full settlement value on the business day following the day of the transaction or on another day stipulated by the regulations.

Being a “cash settlement” instrument, pricing of a SMPIC 90 will not be affected by carrying charge or opportunity cost considerations. “Current”, as opposed to “forward” values, will influence price discovery in the market place. The dynamics of the market can be expected to more closely replicate the dynamics of a Spot Market, rather than those of derivative or forward markets. Redemption regulations will encourage market price convergence with the current calculated value of the underlying Price Index.

SMPICs 90 are not a “geared” instrument and will therefore are enabled to offer international superannuation fund managers the opportunity to acquire, in one simple transaction, a diverse spread of investment exposure for the multi billions of compulsory contributions invested annually. Similarly, other fund and portfolio managers will be able to invest new funds cost effectively through SMPICs 90 and/or tax effectively reduce exposure to the market segments represented by SMPICs 90.

By selling SMPICs 90 instead of the underlying securities in their portfolios, fund and portfolio managers are enabled to reduce exposure to specific markets without incurring capital gains tax on the sale of individual investments, or disturbing their long-term portfolio strategies.

Other advantages of the present invention include:
(i) For a relatively small outlay compared with the prior art or direct investment in the underlying security, investors can acquire exposure to a diversified indexed portfolio representing a specific economic sector or product via a simple “one-stop” transaction;
(ii) Market liquidity is focused through a single traded instrument and is therefore more efficient in raising new funds than is currently the case with the diversity of individual listed funds that disperse market liquidity;
(iii) Authorised Originators 70 gain new fee-bearing funds under management without having to undertake the high costs associated with establishment and marketing of a single name fund;
(iv) Exchange-traded futures and options, based on a SMPIC 90, will benefit from the price discovery dynamics afforded by a liquid and efficient Spot Market which is vital to the success, and tracking reliability, of forward markets; and
(v) SMPICs 90 and their futures and options provide the fundamental building blocks on which investment managers, and advisers, can construct and market a wide variety of diversified investment products to suit individual investors' preferred risk profiles.

Prices for SMPICs 90 are quoted:
(i) in the currency of the Home Exchange of the subject Price Index 80; and/or
(ii) in the currency of the Recognised Exchange 20 where the SMPICs 90 are listed. This latter enables local investors to take a view on, and receive full value for, the direction and amount of movement in the subject Price Index 80 without having to take exchange rate changes into account.

Having two price quotations (as described directly above) affords foreign exchange dealers the opportunity to participate in the markets on their own account, or in conjunction with Market Makers 60 and/or Authorised Originators 70.

In one embodiment, a schedule of fees payable by parties to transactions in SMPICs 90 shall, from time to time, be published by the Clearing House 50. Except where specified to the contrary, the fees will be levied on both sides of a transaction (payable by buyers 30 and sellers 40).

The level of trading fees levied on SMPICs, and their related futures and options markets, will be established by the patentee in collaboration with the index Vendor, the Recognised Exchange 20 and the Clearing House 50.

SMPICs 90 enable the listing of any index, such as a Price Index 80, on a Recognised Exchange 20 for spot and forward markets trading. Examples of the types of Price Indices 80 that could be listed for trading include, without limitation:
(a) consumer price indices;
(b) producer price indices;
(c) primary production price indices;
(d) manufacturing price indices;
(e) currency indices;
(f) housing price indices;
(g) commodity price indices such as the Commodity Research Bureau's:
   (i) energy index;
   (ii) foodstuffs index;
   (iii) metals index;
   (iv) textiles index;
   (v) livestock index;
(h) interest rates indices; and
(i) other internationally recognised economic indicators.

SMPICs markets, when established on public exchanges, create a platform to trade any new or existing Price Indices 80 that are accepted as a reliable measure of a specific commodity, asset or industry performance.

SMPICs markets offer worldwide public Recognised Exchanges 20 and their Members the opportunity to increase the type of Price Indices 80 that can be traded and the volume of trades offered to their index-based derivative customers.

It is envisaged that further embodiments will enable any type of index to be traded on a Recognised Exchange, not only Price Indices,

A preferred embodiment provides one or more interfaces, including software, hardware and computer implemented systems including processing arrangements, with the technology and systems of Recognised Exchanges 20 and Clearing Houses 50.

### Examples of Applications of the Invention

The invention enables SMPICs markets to be established and based on a variety of Indices which are universally accepted as indicators of specific economic activity/sectors. Set out below, by way of example only and without limitation, are applications of the present invention to different types of Price Indices.

### Future Home Buyer

Parents, expecting house prices to rise while their child is growing up, decide to hedge against that eventuality now when their child buys a home some years in the future using SMPICs Sydney Housing Index (contract size=the index multiplied by $20).

Over a period of time they buy 15 contracts at an average index value of 1325.

### Outlay (1325*$20*15)=$278,250

18 years later the child decides to buy a home. Home prices have indeed gone up as reflected in the Housing Price Index having risen by 50%.

The parents sell their 15 contracts at an index value of 1987

### Proceeds (1987*20*15)=$417,270

which the Parents can give to their child to assist with purchase of a home.

By investing in SMPIC Housing index contracts, the parents have made a profit of $139,020 which offsets the rise in the cost of buying a house at the end of the 18 year period.

The important point to note here is that, unlike forwards contracts, SMPICs do not have a maturity/delivery date. They can be held by the buyer for any length of time that suits. Therefore, SIMPICs are an ideally suited instrument for trading Price Indices with long time horizons. A Housing index is only one of many indices which can be the subject of SMPICs.

### Investment Fund Managers

SMPICs will afford investment fund managers opportunities to invest in Price Indices representing specific economic sectors which are not currently available to them. Consequently they will be in a position to diversify portfolio exposure to a much wider representation of economic activity than is available to them through traditional investments. Also the process will be uncomplicated: simple trades in SMPICs instead of complex trading in a multiplicity of individual underlying assets.

Currently investment fund managers sell assets from their portfolios when they anticipate a down-turn in the overall economy or in specific sectors of the economy. SMPICs markets will allow investment fund managers to reduce their exposure to this possibility by selling an index or a series of indices, which represent the economic sectors they have identified as being vulnerable. By taking this action they will not have to go through the often expensive exercise of selling specific underlying investment assets from their portfolios and subsequently repurchasing them.

For example, an investment fund manager decides the value certain shares in the portfolio will be vulnerable to an anticipated downturn in metals prices. Instead of selling those shares from the portfolio, it is decided to sell SMPICs based on the “Commodity Research Bureau Metals Index”. If metals prices fall, the profit from buying back SMPICs is added to the portfolio's value. If metal prices rise the loss from SMPICs will be written off against the increased value of the relevant shares in the portfolio.

### Industry Participants

SMPICs will afford organisations in the entire production chain opportunities to invest in, or hedge against, the price movements of indices representing the specific sectors of the chain in which they operate. They will be in a position to diversify inventory price risk in a much wider representation of economic activities than is available through existing price index markets. These organisations could be operating in any one of the production stages from primary production to retail of end products.

Also the hedging process will be uncomplicated: simple trades in SMPICs, instead of complex trading in a multiplicity of individual underlying assets/inventory items.

For example: a textile manufacturing chain, holding large inventories of a variety of raw materials, may anticipate a slow down in demand for their finished products. Instead of reducing inventory, and therefore production competitiveness, the company could sell Textile Index SMPICs and buy them back when they perceive the risk has abated.

Any profit from the transaction could be booked to the bottom line, while a loss resulting from textile prices continuing to rise would be offset against the rise in value of their inventory.

Similarly, textile processors could buy SMPICs to hedge their future inventory cost. This example can, of course, apply to any producer/processor in the production chain for which SMPIC index markets exist.

### Implementation of the Preferred Embodiment

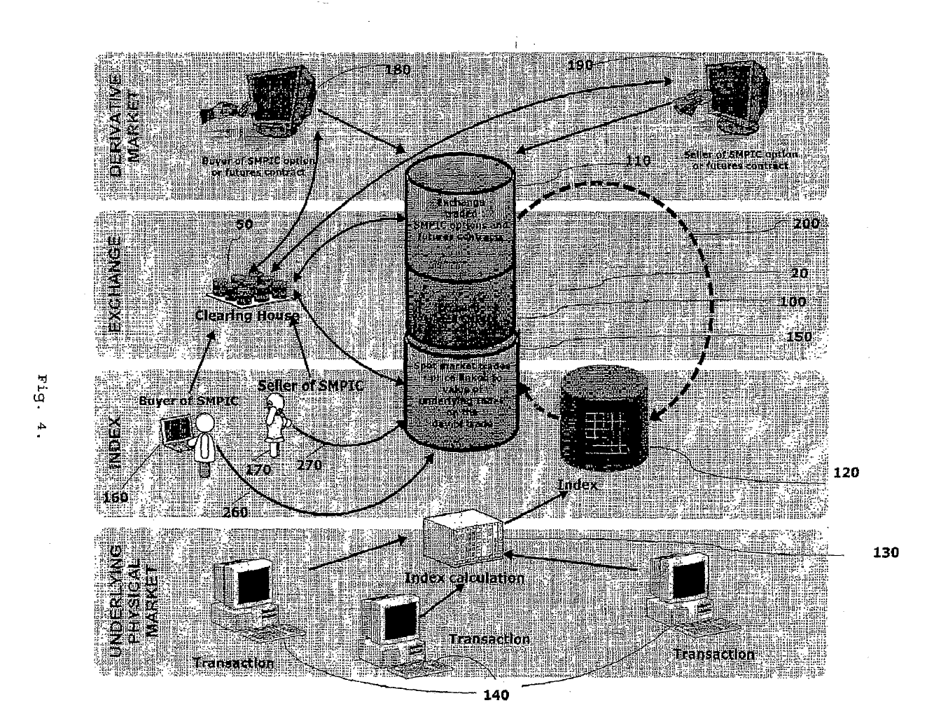

The present invention also relates to a computer-implemented method, system and apparatus for index-based trading on a Recognised Exchange. One embodiment of the invention provides a means for Market Makers and Authorised Originators, including financial institutions, fund and portfolio managers, to offer index-based trading to the market without the need to create and list managed index-based funds. As shown in FIG. 4, trading may be in the form of:
(a) primary issue SMPIC trading 100; and/or
(b) secondary trading in SMPIC derivatives 110.

FIG. 4 illustrates a preferred embodiment of the system for index-based trading including software, hardware, databases and other data, and computer-implemented methods and processes that provide:
(a) means for Market Makers and Authorised Originators (including financial institutions, fund and portfolio managers) to issue a SMPIC for public trading (not shown);
(b) means for Market Makers and Authorised Originators (including financial institutions, fund and portfolio managers) to offer exchange-traded futures and options based on a SMPIC trading (not shown);
(c) means for a seller to determine a sale price (offer) for a SMPIC 170, expressed in the currency of the Home Exchange and based on the current value of the relevant index as published by the index Vendor;
(d) means for a buyer to determine a buy price (offer) for a SMPIC 160, expressed in the currency of the Home Exchange and based on the current value of the relevant index as published by the index Vendor;
(e) means for a seller to list a sale price (offer) for;
   i. spot trading of a SMPIC 270 on a Recognised Exchange; and
   ii. options or futures trading of a SMPIC 190 on a Recognised Exchange;
(f) means for a buyer to list a buy price (offer) for:
   i. spot trading of a SMPIC 260; and
   ii. options or futures trading of a SMPIC 180 on a Recognised Exchange;
(g) means to record the price at which a buyer and a seller agree to trade a SMPIC;
(h) means to determine the value for settlement of a trade between a buyer and a seller, calculated on the amount of the Price Index 120 on the day of the transaction;
(i) means to record settlement details, including transaction date, settlement date, parties and trade price;
(j) means to exchange trade and party information with a Clearing House, including settlement details and other relevant information;
(k) means to exchange trade and party information with an Exchange;
(l) means to record Price Index 120 information in relation to one or more Indices, including means to record historical Price Index value and to update Price Index value on a time basis (e.g. daily, weekly, or any other specified time interval);
(m) means to chart the historical, current and forward pricing of a SMPIC, as well as the volume and nature of trades in a SMPIC;
(n) means for sellers, other than Authorised Originators, and buyers who sell their bought SMPICs to lodge cover with the Clearing House against fulfilment of their obligations;
(o) means to calculate all fees and charges payable in relation to a trade and associated transactions;
(p) means to deduct fees and charges from the account of the party liable to pay the fee or charge;
(q) means for porting the computer-implemented system, including methods and processes performed by software, onto the electronic trading system of a Recognised Exchange or other trading platform that enables public trading through a Recognised Exchange;
(r) means, including tools, for researching and notifying market opportunities.

### Information Data Sources

FIG. 4 is a schematic illustration of a computer-implemented system for index-based trading on a Recognised Exchange 20 according to the invention. A SMPIC enables spot market trades (260, 270) of the value of an index, as well as secondary trading in index-based derivatives 110 without having to create and list managed index-based funds. This is enabled by a SMPIC being publicly listed on a Recognised Exchange 20 through the establishment of informational databases:
a) a primary issue SMPIC database 100, which records details of SMPICs available for public trading;
b) a secondary trading 110 database, which records SMPIC options and futures contracts available for public trading;
c) a SMPIC trade defined states database, which is a database recording, for example:
   (i) the position or state of a SMPIC contract as it occurs (e.g. whether SMPIC is in sold position or in open position and, if sold, Redemption Value, Settlement Value and other relevant details);
   (ii) buyers who have purchased one or more SMPICs on the spot or derivatives market;
   (iii) sellers who have sold one or more SMPICs on the spot or derivatives market;
   (iv) the number of SMPIC contracts (on spot and derivative markets) relating to any given index;
   (v) buyers awaiting purchase of a SMPIC contract (spot and derivative) and their buy price offer;
   (vi) sellers awaiting sale of a SMPIC contract (spot and derivative) and their sell price offer;
d) a spot market database 150 for recording details of spot trades in SMPICs; and
e) an index database. The index 120 forms the basis of an exchange traded SMPIC listed for public trading on a Recognised Exchange 20. The index database reflects the index calculation 130 of the plurality of underlying physical market trades 140. The value of SMPIC trades on the spot market and secondary trading in index-based derivatives 110 is linked to the value of the underlying index.

Communication between the following enables dynamic assessment of the market as trades occur:
d) the Recognised Exchange 20, which provides and receives transactional data to and from a Clearing House 50 along with data from:
   (i) a primary issue SMPIC trading database 100, which records details of SMPICs contracts available for public trading, including the current value of the relevant underlying index 120;
   (ii) a secondary trading in index-based derivatives 110 database, which contains transactional data regarding:
      D. a buyer 160 of SMPIC derivatives; and
      E. a seller 170 of SMPIC derivatives;
      F. the current value of the relevant underlying index 120;
   (iii) a Spot Market SMPIC database 160, which contains transactional data regarding:
      i. a buyer 260 of SMPIC on the Spot Market;
      ii. a seller 270 of SMPIC on the Spot Market; and
      iii. the relevant underlying index 120;
e) the Clearing House 50, which records and provides, among other information, SMPIC transactional data regarding:
   (i) a buyer of a SMPIC 160;
   (ii) a seller of a SMPIC 170;
   (iii) a buyer of a SMPIC option or futures contract 180;
   (iv) a seller of a SMPIC option or futures contract 190;
   (v) financial and other details (e.g. transaction date, settlement date) of a trade;
f) the index Vendor (or a third party), which:
   (i) receives market data from a plurality of underlying physical market transactions 140;
   (ii) calculates, updates and publishes the value of the index 120 in accordance with the relevant regulations; and
   (iii) provides index 120 data to a Recognised Exchange 20 for primary issue SMPIC trading 100.

The term database is used to include any data repository or other means for storing, sorting, ranking, searching or otherwise accessing information.

Secondary trading of index-based derivatives database 110 contains the detail of secondary trading in SMPICs contracts at any day whilst Spot Market trades are recorded and monitored in the Spot Market database 150.

The existence of a public Spot Market for index-based trades enables reconciliation 200 of the value of SMPICs derivative trades. The Spot Market provides a reference point for Settlement Value for forward and option SMPIC contracts, which are linked back to the value of underlying Price Index 120. This provides a means for reconciling the settlement value 200 of index-based derivatives with the underlying value of the index.

A SMPIC defined state database records the range of outcomes from a plurality of events that result in a price movement, either immediately or on some future occasion. This provides additional information to feedback into the Spot Market 160. These defined states assist in the assessment of the market by ascertaining the options available to buy, hold or sell SMPICS, or SMPIC futures and options. The probability of movement with specific options available as defined states is a stabilising feature of the SMPIC market that enables reconciliation of the value of forwards contracts to the value of the relevant underlying index. Moreover, new SMPIC defined states can be established upon the occurrence of new events and forms of trade in the spot and forward market.

### Trading Enablement

Trading of an index 120 on a Recognised Exchange 20 is enabled by the primary issue of one or more SMPICs for public trading of that index. The primary issue database 100 records details of one or more SMPICs available for public trading, including details of the index on which it is based. The primary issue database 100 communicates with the Exchange and Clearing House.

The inventive system also enables communication and comparison between the primary issue database 100, the spot market database 150 and the secondary trading database 110. This provides information relating to spot and forwards trading, which is useful for research purposes. The preferred embodiment contains research means and tools, including means to perform searches within and across the databases described above and to generate electronic and written reports (including charts) such as:
a) performance of underlying indexes (including historical and current index calculations and Index predictions); and
b) performance of a given SMPIC in the spot market (including, for example, the value and volume of spot market SMPIC trades in a particular index in a specified time period such as daily, monthly, quarterly, annually);
c) performance of a given SMPIC derivative (including, for example, the value and volume of trades in SMPIC futures for a given index in a specified time period);
d) comparison of the value and volume of spot market trades with the value and volume of derivative trades for a given index or across all available Indexes in a specified time period.

Communication between databases in the preferred embodiment is enabled by:
a) a communication processor, which can be a plurality of processors; in a preferred embodiment, the communication processor operates via a grid processing arrangement, since the Recognised Exchange that provides the trading platform may not house the index that is the subject of a SMPIC trade. This communication processor enables Spot Markets to be monitored based on one or more Price Indices 80 together with their associated derivative markets;
b) a communication means to communicate data between the databases and the trading platform;
c) an information processor to provide data and graphical representations, on a computer screen (or any other information display device), of the price movements, current status of a SMPIC (e.g. in open position) and events open and closed for review as transactions take place. This information processor is enabled to provide the above detail by having an interface communicating with the databases, the communication processor(s) and the relevant index underlying a SMPIC;
d) a Clearing House communication means to provide information from said Clearing House to the information processor (regarding clearing, settlement and novation of a SMPIC), and to the relevant databases.

A trading processor, interface and communication means to enable trading of the value of an index, the trade price being as agreed between buyer and seller, in accordance with the rule based instruction programmed from the regulations of the Recognised Exchange, where the transaction takes place, expressed in the currency of the Home Exchange. A price so agreed shall be the amount used to determine the value for settlement between the parties to the transaction and communicated to the Clearing House by the Clearing House communication means.

The Clearing House 50 holds all SMPIC contract and holder's details. The Clearing House 50 will also maintain a register of all SMPICs bought and paid for in full. This register will detail the buyer's (owner's) name, address and other identification required at law. The Clearing House may substitute the names of parties to a SMPIC by novation. The Clearing House's register will communicate detail to and from the secondary trading database 110 and the spot market trading database 100, as required;

The communication processor contains sub-processes to monitor the primary, Spot and forward markets. This is enabled by the SMPIC being a “cash settlement” instrument, therefore reflecting the qualities of a Spot Market. The “current” Spot Market transactions influence price discovery 200 as communicated to the Information Processor. Redemption regulations will encourage market price convergence with the current calculated, by the trading processor, the value of the underlying Price Index.

These databases and processors are attached to the trading platform of a Recognised Exchange (and/or third party trading platform) as a modular addition which will utilise the application program interfaces (APIs) of the specific Exchange as required. It would be appreciated by those skilled in the art that the particulars of the modularisation or other means to place the inventive system, processes and methods onto a trading platform of a Recognised Exchange (and/or third party trading platform) are specific to each Exchange and trading platform and would be implemented on a case by case basis.

As will be appreciated by those persons skilled in the art, the present inventive method and system affords distinct business advantages not previously available.

Although the invention has been described with reference to the exemplary and specific embodiments thereof, it will be appreciated by those skilled in the art that the invention will be may be embodied in many other forms without departing from the scope of the invention.

### Annexure 1

### Sample Trading Regulations

### Introduction

SMPICs may be quoted for trading on Recognised Exchanges approved by the Clearing House.

Trading in SMPICs shall be conducted in accordance with the Articles of Association, By-Laws and Regulations of the Approved Exchange, except in so far as these regulations are in conflict with those of the Approved Exchange, these regulations shall be adopted by (or recognised as superseding those of) the Approved Exchange.

Trading Regulations shall apply to all transactions in SMPICs.

These regulations may only be amended or deleted upon the written recommendation of the Clearing House and with the written consent of not less than 75% of approved Issuers.

### A. Regulations

### 1. Issuers

SMPICs issued by Clearing House Members in accordance with the regulations shall be eligible for trading under these regulations.

### 2. Approved Exchanges

The Clearing House shall from time to time declare those Recognised Exchanges which have been approved to conduct trading in SMPICs.

### 3. Trading

Trading in SMPICs shall be conducted in accordance with these Regulations and the Articles of Association, By-Laws and Regulations of an Approved Exchange.

All transactions in SMPICs shall be carried out at an Approved Exchange through a member of the Approved Exchange. No other transactions shall be recognised by the Clearing House.

### 4. Official Matching

Official meetings of Approved Exchange members will be held each business day for the purpose of conducting a matching of orders at the declared index Unit Value at the close of the morning and afternoon trading sessions of the Home Exchange. The time of commencement of such meetings shall be no later than thirty minutes prior to the close of trading of the morning and afternoon sessions, respectively, of the Home Exchange for the index represented by the SMPICs.

Orders, which will be ranked on a “First Come, First Served” basis, will be accepted for the official matching up to the time of completion of the matching, but, once having been Lodged, shall not be withdrawn before such time.

Completion of the matching shall be declared when all buy and sell orders which are capable of being matched, have been matched and there are no remaining “buy” orders to satisfy “sell” orders—or “sell” orders to satisfy “buy” orders, as the case may be.

Official matching meetings shall close no later than five minutes before the close of trading of the relevant session at the Home Exchange.

To assist issuers, whose SMPICs are presented for redemption, to replace their positions at the redemption price, and to encourage holders to “trade out” their SMPICs rather than to redeem them, there will be a computerised facility to match buy and sell orders at the Index Unit value declared at the close of each morning trading session of the Home Exchange. The facility will close prior to announcement of the index value by the Home Exchange, and can be re-opened to match orders at the index Unit Value declared at the close of each afternoon trading session on the same basis.

(It is recommended that issuers' redemption and replacement transactions be free of all fees, and, to encourage holders to sell SMPICs to the market, redemption fees for holders be at least double the prescribed trading and clearing fees.)

### 5. Registration

Buyers and sellers who enter into transactions which are carried out in accordance with these regulations shall be registered by the Clearing House in individual registration accounts for each buyer and each seller.

The Clearing House shall have the right, at its sole discretion, to accept or reject a transaction for registration.

Transactions which are not registered by the Clearing House shall not, under any circumstances, be the subject of the guarantee of performance.

### 6. Closing Transaction

A buyer having first sold a SMPICs, or a seller having first bought a SMPICs, may request the Clearing House to “match out” or “close” the opposing transactions, and shall be relieved of their obligations under the relevant SMPICs.

### 7. Price

The price at which Index Units are traded shall be the amount of the Price Index, which is the subject of such Index Units, agreed between buyer and seller, in accordance with these regulations and those of the approved Exchange where the transaction takes place, expressed in the currency of the Home Exchange.

A price so agreed shall be the amount used to determine the value for settlement between the parties to the transaction.

### B. Settlement of Transactions

### 1. Sellers Obligations

### (i) Issuers' Security Deposits

Clearing member drawers (issuers) of SMPICs which have first been issued, lodged with and endorsed by, the Clearing House and are subsequently sold, will be entitled to receive a proportion of the value, which will be determined by the Clearing House at its sole discretion.

The balance of the sale proceeds will be held by the Clearing House, to the account of the issuer, as a security deposit against the issuer's obligations to perform in accordance with these regulations.

The issuer may elect to lodge acceptable security, to a value equal to or greater than the cash amount withheld by the Clearing House as a security deposit, and shall receive sale proceeds in full.

The Clearing House shall, from time to time and at its sole discretion, declare the proportion of the value of a SMPIC it will hold for security deposits, and will publish a list of instruments and the proportion of their value it will accept as cover in lieu of cash.

In the event that the new level of security deposit is higher than previous levels, all issuers shall lodge additional cash or instruments to cover the new security deposit.

### (ii) Private Investors

All other sellers of SMPICs shall have first bought SMPICs in the market and will be entitled to payment of full settlement value on the business day following the day of the transaction.

### 2. Buyers Obligations

Clearing House members who have issued and sold SMPICs to the market may buy back at any time and shall pay the settlement value on the business day following the day of the transaction.

All other buyers shall pay the settlement value to the Clearing House with cleared funds (if the Clearing House so insists) on the business day following the day of the transaction, and their proprietorship shall be registered with the Clearing House which may substitute certificating parties with other certificating parties by novation.

SMPICs do not entitle holders to any dividend income.

### C. Fees

A schedule of fees payable by parties to transactions in SMPICs shall, from time to time, be published by the Clearing House.

Except where specified to the contrary, the fees will be levied on both sides of a transaction (payable by buyers and sellers) and will include:

### 1. Transaction Fees

A transaction fee, determined by the Clearing House and an Approved Exchange jointly, shall be levied on each Index Unit which is the subject of a transaction.

Transaction fee income will be for the account of the Approved Exchange on which transactions are effected.

The purpose of this fee is to provide income to Exchanges where SMPICs are traded. It is recommended that the fee be an amount approximately equivalent to a clearing fee.

### 2. Clearing Fees

The Clearing House will determine the level of fees it will charge for its services. Clearing fees will be levied on each Index Unit which is the subject of a transaction and shall be to the account of the Clearing House.

### 3. Endorsement Fees

In recognition of the risk associated with the performance guarantee which is undertaken by the Clearing House, it is recommended that an endorsement fee, of an amount approximately equivalent to the clearing fee, be levied.

A proportion of the income from endorsement fees could be set aside to pay volume rebates under a clearly defined formula.

Endorsement fees shall be levied on each Index Unit which is the subject of a SMPIC, but will not be levied on closing transactions.

The net income from endorsement fees shall be to the account of the Clearing House and its members in direct proportion to the quantity of their participation in the performance guarantee agreement.

### D. Licensing Agreement

The Licensing agreement between the Clearing House and drawers (issuers) of SMPICs should, at the minimum, contain the following elements:

### 1. Qualifications for License Applicants

The applicant:
(i) Shall be a member of the Clearing House;
(ii) Shall have at least the minimum amount of net fiends under management required by legislation (and/or the applicable regulations, rules, by-laws or code);
(iii) Shall have at least the minimum amount of net liquid assets as required by legislation (and/or the applicable regulations, rules, by-laws or code) wider which the drawer carries out its business;

### OR

(iv) If they are more onerous, shall meet the qualifications required of applicants for membership of the Clearing House.

### PLUS

(v) Shall be an investment institution incorporated, recognised and authorised under the relevant securities legislation of the country in which the Clearing House is incorporated, and/or of the country of the home exchange of the indices which are the subject of the SMPICs which are issued by the drawer;

### 2. Elements of License Agreement

At least 75% (or a percentage to be determined and specified in the applicable regulations, rules, by-laws or codes) of all SMPICs licensees must first give consent in writing for the Clearing House to enter into a License Agreement with a new licensee.

The licensees jointly and severally agree to guarantee performance of the drawer's obligations under SMPICs endorsed by the Clearing House, provided that the Clearing House, if it joins the guarantee, clearly limits the extent of its liability in respect of the guarantee, and its members who are not licensees are not in any way held liable for licensees' obligations.

To become eligible for sale and issue to other parties SMPICs drawn by a licensee shall first be presented to the Clearing House for endorsement and the Clearing House shall have the sole discretion to accept or reject SMPICs so presented.

SMPICs which do not bear the endorsement of the Clearing House shall not be recognised as valid instruments under this agreement, the regulations of the Clearing House and/or the regulations for SMPICs.

The licensees agree that they will not issue SMPICs or any other like instrument to parties, other than those approved by the Clearing House, without first obtaining the approval in writing of the Clearing House and an application for dispensation under this clause shall quantify the increase in the licensee's exposure which would accrue as a result of such issue.

The Clearing House shall have the sole discretion to determine and vary the amount of sale proceeds it withholds, from issuers of SMPICs it has endorsed, as a security deposit against performance of the issuers' obligations.

In the event a Licensee fails to meet its financial obligations or infringes any articles of association, by-laws or regulations relevant to SMPICs, or infringes any of the clauses herein, the Clearing House shall have at its absolute discretion the right to obtain from the Licensee compensation for any losses or damages suffered by the parties to the SMPICs issued by the licensee which may arise as a consequence of the licensee's infringements, and the licensee shall account to the Clearing House for the costs associated with recovery of the compensation.

Notwithstanding the generality of this clause, action taken by the Clearing House to recover compensation may include the repurchase of all the licensee's outstanding SMPICs issued to the market at the cost, and to the account, of the licensee.

The licensee agrees to abide by any decisions made by the Clearing House in accordance with this agreement, the regulations of the Clearing House and the regulations for SMPICs.

(The purposes of the licensing agreement are:

(i) to create a single instrument with uniform risk,
(ii) to formalise and provide the opportunity for regulation of the price discovery process and,
(iii) to provide the Clearing House and market regulators with a clear and current picture of each licensee's exposure to SMPICs or any other similar instruments so that, if thought necessary, action may be taken, or measures adopted to protect the integrity of SMPICs.

They are not intended to relieve, nor may they be construed as relieving, individual licensees of their fiduciary obligations in law.

It is recommended that Licensees pay an entrance fee which could be set at a level which would go some way to establishing the bona fides of applicants.)

### E. Definitions

The definitions contained in these sample Regulations (Annexure 1) apply only to this Annexure and not to the patent specifications as a whole.

### 1) Index Unit

An Index Unit represents the amount of the index, which is the subject of such Index Unit, declared by the Home Exchange of the index to be the amount calculated at the close of trading of the morning session on a business day.

### 2) Index Contract

An Index Contract is an irrevocable undertaking by the drawer (issuer), and endorsed by the Clearing House, to pay to the bearer the value of the number of Index Units represented by the SMPIC as determined under clause 7 hereof.

### 3) Home Exchange

The Home Exchange of an Index Unit is that Exchange which calculates the index which is the subject of such Index Unit.

### 4) Clearing House

The Clearing House is the organisation which undertakes to clear (including registration, settlement of, and accounting for) SMPICs on behalf of its members and members &/or clients of the Exchange(s) it formally approves to conduct a secondary market in SMPICs.

### 5) Drawer

The drawer (issuer) of a SMPIC shall be a member of the Clearing House and shall agree to abide the articles of association, by-laws and regulations of the Clearing House.

In addition the drawer shall enter into an undertaking with Clearing House to honour its obligations under index Contracts. The undertaking may only be revoked in the event there are no outstanding SMPICs issued by the drawer.

### 6) Endorsement

The endorsement by the Clearing House shall certify that the drawer is a member of the Clearing House and that the instrument is the subject of a guarantee of performance by the Clearing House.

### 7) Value

a) Index Unit—The value of an Index Unit is the amount of the index declared by the Home Exchange to be the value of the index, which is the subject of an index Unit, at the close of trading of the morning session on a business day of the Home Exchange. Such value shall be expressed in the currency of the country of the Home Exchange.

b) Index Certificates—The value of a SMPIC is calculated by applying the index Unit value, as determined in 7a hereof, to the number of Index Units represented by the SMPIC.

### 8) Settlement

a) Bearers, who have bought and paid for SMPICs through an Exchange recognised by the Clearing House, may present SMPICs for redemption at the Clearing House on business days and during normal business SMPICs hours but by no later than a regular time of day which the Clearing House will, from time to time, declare.

Issuers of SMPICs which have been presented for redemption in accordance with these Regulations shall be notified of such presentation by no later than the specified period before the time of the Official Fixing stipulated by the Trading Regulations.

SMPICs presented for redemption may not be withdrawn.

b) SMPICs presented for redemption subsequent to the time in clause 8a above shall be deemed to have been presented for redemption on the next business day of the Home Exchange.
c) The value for redemption shall be the amount calculated in accordance with clause 7b hereof by reference to the next index Unit Value declared by the Home Exchange immediately subsequent to the time of presentation by the bearer.
d) Upon declaration of the relevant index Unit Value referred to in clause 7a, the Clearing House shall advise the value for redemption to both parties.
e) Issuers notified under clause 8d hereof shall pay to the Clearing House, and the Clearing House shall pay to the bearers of the SMPICs so presented, the redemption amount, by no later than the close of business on the business day following the day of notification.
f) In the event the Home Exchange ceases to calculate the index which is the subject of a SMPIC, the drawers of all SMPICs on issue in the market shall pay to the Clearing House, and the Clearing House shall pay to the bearers of such SMPICs, the redemption value determined in accordance with clause 7 hereof. The redemption value determined under this clause shall be calculated by reference to the index Unit Value on the day prior to the day on which the index ceases to be calculated.

(The foregoing clauses define the instrument itself).

The settlement procedures provide a mechanism for establishing its precise value upon presentation for redemption.

By allowing for this method of redemption, prices established in a secondary market will be consistently influenced by the actual current value of the index the SMPIC represents.

The procedure takes cognisance of the possibility the Clearing House may operate in a different time zone to that of the Home Exchange of the index which is the subject of a SMPIC.

The instrument will only be issued to and traded by participants in a secondary market, approved by the Clearing House, wherein value will be established by the price discovery process and the settlement procedures for which will be undertaken by the Clearing House.

Index Unit Value is based on a “mid trading session” index to ensure accurate “tracking” by the market, and to allow issuers whose SMPICs have been presented for redemption to replace their positions in the market with minimum divergence between the redemption value and market price.

### F. Sample By-Laws

The definitions contained in these by-laws relate only to the by-laws and do not apply to the patent specifications as a whole.

A. Unless the context otherwise requires, words and expressions in these by-laws shall have the meaning assigned to them in the Articles of the Recognised Exchange. In addition the following words and expressions when used in these by-laws shall have the meaning assigned to them hereunder:
Approved Sales Record means the form of sales records for index Contracts prescribed by the board from time to time.
Articles means the Articles of Association of the Recognised Exchange as amended from time to time.
Bought Position, in relation to an index Contract, means the position of a party to the contract whose obligations and rights under the contract include:
(i) an obligation to pay to the Clearing House the value or worth of the contract (as determined by reference to the traded price of the contract) in accordance with the regulations of the Clearing House and the Recognised Exchange.
(ii) the right to call upon the Clearing House, in the manner prescribed from time to time by the Recognised Exchange and the Clearing House, to pay the value or worth of the contract as calculated by reference to the published amount of the subject index. Such amount shall be calculated and published by the index Vendor at a time on each business day to be prescribed by the Recognised Exchange.
Broker's License means a broker's license granted under the relevant code, regulations, by-laws and/or legislation.
Call means:
(i) the demand for payment of a sum of money made upon a member and/or a client; or
(ii) the demand for payment as in “Bought Position” clause (ii) above.
Client, in relation to a member of a Recognised Exchange, means a person on behalf of whom such member accepts instructions to deal in index Contracts.
Client's Segregated Account means, in relation to a Member Organisation, an account that:—
(i) is maintained by the Member Organisation with a banking corporation;
(ii) is designated as a client's segregated account; and
(iii) does not contain money other than money deposited by the Member Organisation in the account pursuant to the Regulations
Close Out means the act of obtaining an index Contract which has the opposite obligation of a contract already held whereby:
(i) the Clearing House may match the two contracts thereby satisfying the respective obligations of settlement, and
(ii) the obligations to pay moneys may be satisfied immediately by actual payment or the raising of appropriate credits or debits between the parties,
   OR
settlement pursuant to the contract.
Cover means money and/or property held by a Member Organisation against a client's liability from time to time.
Deposit means:
(i) in respect of an index Contract opened by a Member Organisation on its own account, the amount payable to the Clearing House by the Member Organisation in respect of the index Contract; or
(ii) in respect of a index Contract opened by a Member Organisation on the instructions of a client, the amount payable by the client to the Member Organisation in respect of the index Contract.
Exchange Examining Accountant means the accountant or firm of accountants appointed by the board pursuant to the Recognised Exchange's regulations.
Exchange Inspector means the person or persons appointed by the board pursuant to the Recognised Exchange's regulations.
Family Company means a corporation controlled by one or more of a partner, director, employee, officer or consultant of a Member Organisation or their immediate families.
Family Trust means a trust in respect of which a partner, director, employee, officer or consultant of a Member Organisation or their immediate families:
(i) is, are or may be a beneficiary; or
(ii) has the ability of removing the person acting as trustee of the trust and replacing that person with its own nominee.
Immediate Family in relation to a person means that person's spouse and non-adult child.
Index means the calculation of the amount of the index which is the subject of the contract, made and published at the prescribed time on each business day by the index Vendor.
Index Vendor means the organisation appointed by the Recognised Exchange to calculate and publish the index(es) which are the subject of contract(s) traded at the Recognised Exchange
Margin means the difference between the value of an index Contract as shown on the contract and the value of that contract at any given time on or before Close Out.
Member Organisation means a body corporate which has been admitted to membership of the Recognised Exchange in accordance with its Articles.
Index Contract means an undertaking by the seller of such contract to pay the Redemption Value on demand by the buyer.
Redemption Value means the value of an index Contract as calculated in accordance with the definition “Bought Position”.
Open Position means the situation where the rights and/or obligations under an index Contract are not fulfilled.
Recognised Exchange means an exchange recognised by the Australian Securities and Investment Commission or an equivalent authority in relation to an exchange outside Australia.
Sold Position means, in relation to an index Contract, the position of a party to the contract whose obligations under the contract include the obligation to pay the Redemption Value on demand.
the Regulations means these Regulations as amended from time to time.

B A reference to a Member Organisation taking the other side of an order of a client in relation to an index Contract shall have the meaning ascribed to such a reference in the Regulations.

C A reference to a Member Organisation dealing in an index Contract, or entering into a transaction, on the Member Organisation's own account includes a reference to a Member Organisation dealing in an index Contract, or entering into a transaction:
(i) on behalf of a person associated with the Member Organisation;
(ii) on behalf of a body corporate in which the Member Organisation has a controlling interest; and
   a Member Organisation shall not be taken to be dealing in an index Contract, or entering into a transaction, on the Member Organisation's own account by reason only that the dealing is with, or the transaction is entered into with, another Member Organisation or a member of another Recognised Exchange.

D A reference to a person associated with another person shall have the same meaning ascribed to such a reference in the Securities Code or any other code stipulated by the relevant regulations, legislation, by-laws or rules provided that for the purposes of paragraph C (i) above a Member Organisation shall not be associated with a person by reason only that the Member Organisation is a director of a body corporate of which the person is also a director, whether or not the body corporate carries on a business of dealing in index Contracts.

E A reference to a Substantial Shareholder in a corporation is a reference to a person who is or would be a Substantial Shareholder if the Securities Code applied to that corporation.

### G. Accounts, Audit, Capital Requirements and Surveillance of Members

### 1. Capital Liquidity Requirements

1.1 (i) Subject to sub-clause (ii) below, a Member Organisation shall ensure that at all times the Adjusted Liquid Capital in its business is not less than an amount to be determined and stipulated within the relevant regulations, by-laws, rules or codes, either as a cash amount or a percentage of Aggregate Indebtedness, whichever is the greater.
   (ii) a Member Organisation carrying on a business on its own account or in partnership with other Member Organisations shall ensure that at all times the Adjusted Liquid Capital in its business is not less than an amount to be determined and stipulated within the relevant regulations, by-laws, rules or codes, either as a cash amount or a percentage of the Aggregate indebtedness, whichever is the greater.
1.2 The board may at any time, or from time to time in the case of a particular Member Organisation, grant an exemption from this Regulation on such terms and for such periods as the board may from time to time think fit.
1.3 Each Member Organisation shall promptly notify the board if its Adjusted Liquid Capital is at any time less than the amount required by this Regulation.
1.4 In this Regulation:
   (i) Adjusted Liquid Capital means the aggregate of
      (a) Liquid Capital
      (b) Approved Adjustments; and
      (c) Approved Subordinated Debt.
   (ii) Aggregate indebtedness means the total liabilities of a Member Organisation (including the Deposit and Margin liabilities of the Member Organisation accrued in respect of Index Contracts held by the Member Organisation) but excluding the following:
      (a) amounts borrowed which are adequately secured by assets owned by any of the directors or shareholders not included in the Balance Sheet of the Member Organisation;
      (b) amounts due to or received from clients and held in accordance with the Regulations;
      (c) amounts due to or received from clients in relation to any other business conducted by a Member Organisation in addition to its activities as a broker and held by the Member Organisation in a trust account of the Member Organisation;
      (d) the value of property calculated and held in accordance with the Regulations; and
      (e) Approved Subordinated Debt.
   (iii) Approved Adjustments means the inclusion of those assets which would not otherwise be included in Liquid Capital but which are considered capable of realisation within the applicable period specified by the Regulations (to be determined). This capability must be demonstrated to the Recognised Exchange Examining Accountant and the Chairman to their satisfaction prior to their inclusion in Adjusted Liquid Capital.
   (iv) Approved Subordinated Debt means an amount owing by a Member Organisation which is payable at a time or by installments approved by the board and is to the satisfaction of the board effectively subordinated so that any right of the creditor in question to receive payment in the case of bankruptcy of or any composition or compromise with creditors by or appointment of a trustee in bankruptcy or in the case of liquidation, liquidator in respect of the Member Organisation or directors or any of them is extinguished to such extent as will ensure payment or provision for payment in full of all other present and future creditors of the Member Organisation in priority to the claim of the subordinated creditors and in respect of which a Subordinated Loan Deed has been executed under seal by the Member Organisation, the lender and the Recognised Exchange and which contains provisions which may be imposed by the board having regard to the nature of the business conducted or to be conducted by the Member Organisation and which shall have a capital structure which complies with the Regulations.
   (v) Approved Subordinated Loan Deed means a deed approved by the board which shall include provisions to the following effect:
      (a) no alteration is to be made to the deed without the agreement of all parties and such variation shall be executed under seal by all parties to the deed;
      (b) full details of the terms and conditions governing each loan are set out in the deed and in particular that the Recognised Exchange can be satisfied that the borrower has made adequate arrangements to cover liquid asset requirements upon the maturity date of any loan for a fixed term and, is to be advised full particulars of each loan prior to the making thereof;
      (c) repayment of the loan in whole or in part shall not take place without the prior approval of the board and that the board shall withhold its consent if it is not satisfied that the Member Organisation is capable of continuing to comply with any of these Regulations or any conditions of its broker's license following repayment of a loan;
      (d) specific acknowledgement by the tender that any right of the lender to payment in the case of bankruptcy of or any composition or compromise with creditors by or appointment of a trustee in bankruptcy or in the case of liquidation, liquidator in respect of the Member Organisation or the directors or any of them is extinguished to such extent as will ensure payment or provision for payment in full of all claims of all other present and future creditors of the Member Organisation in priority to the claim of the lender;
      (e) specific acknowledgement by the lender that any right to receive interest and principal payments, are subordinated at all times during the time of the loan, to all other creditors; and
      (f) specific acknowledgement by the lender that the obligation to repay the loan, and to pay interest, is suspended if net capital falls below the minimum set for the borrower's brokers' license.
   (vi) Excluded Assets means the exclusion of the following assets from current assets when calculating Liquid Capital:
      (a) assets which have no ready market;
      (b) all loans and amounts to, or amounts owing by any of the following parties:
         (i) in respect of a Member Organisation:
            1. directors, officers or other employees of the Member Organisation, their immediate Families, Family Companies and Family Trusts;
            2. a subsidiary or related corporation of the Member Organisation;
            3. Substantial Shareholders of the Member Organisation when these loans and amounts owing to or by them are for their own account unless exempted by the Recognised Exchange Examining Accountant;
            in this Regulation a reference to an amount or loan owing by a Substantial Shareholder for its own account means that the amount or loan owing appears or would appear as a liability on the balance sheet of the Substantial Shareholder's assets and liabilities (subject to any exceptions to be determined and stipulated in the Regulations); and
         (ii) other associated persons (the meaning of this term is to be determined and stipulated in the Regulations);
         to the extent to which such loans are not secured by listed investments valued at net realisable values or any other investments approved by the Recognised Exchange Examining Accountant and the Chairman;
      (c) amounts owed by clients, the recovery of which is doubtful or not capable of realisation within thirty days or other period stipulated in the Regulations;
      (d) other current assets which are not capable of realisation within thirty days or other period stipulated in the Regulations;
   (vii) Liquid Capital means the sum of total current assets valued at the lower of cost or market (including Deposit and Margin entitlements of the Member Organisation accrued in respect of the index Contracts held by the Member Organisation), adjusted by deducting total liabilities and any Excluded Assets included in current assets.
1.5 A Member Organisation shall at the time of entering into an Approved Subordinated Loan Deed be required to have the minimum paid up capital required by the Regulations (of an amount to be determined).

### 2. Records

2.1 A Member Organisation shall keep and maintain in sufficient detail to show particulars of
   (i) all moneys received or paid by the Member Organisation in relation to its dealing in index Contracts, including moneys paid to, or disbursed from, Clients' Segregated Accounts;
   (ii) all dealings in index Contracts made by the Member Organisation, the charges and credits arising therefrom, and the name of the person on whose behalf each dealing was effected;
   (iii) all income received from commissions, interest and other sources, and all expenses, commissions and interest paid by the Member Organisation in relation to its dealings in index Contracts;
   (iv) all the assets and liabilities (including contingent liabilities) of the Member Organisation;
   (v) all index Contracts to which the Member Organisation has become a party as a result of dealing in index Contracts on its own account;
   (vi) all index Contracts dealt with by the Member Organisation pursuant to instructions given by another person, showing who gave the instructions;
   (vii) all property of the Member Organisation in respect of which these Regulations authorise the making of an index Contract at a contract market showing by whom the property is held and, if held by some other person, the name of that person and whether or not the property is held as a security against loans or advances; and
   (viii) all such property that is not property of the Member Organisation and for which the Member Organisation or any nominees controlled by the Member Organisation is accountable, showing by whom, and for whom, the property is held and the extent to which the property is either held for safe custody or deposited with a third party as security for loans or advances made to the Member Organisation.
2.2 Without affecting the operation of any other Regulation, a Member Organisation shall keep records in sufficient detail to show separately particulars of all transactions relating to index Contracts entered into by the Member Organisation on its own account or with, on behalf of, or on the account of:
   (i) clients of the Member Organisation;
   (ii) employees, consultants or representatives and their immediate families, Family Companies and Family Trusts;
   (iii) in respect of a Member Organisation:
      (a) the directors, officers or other employees of the Member Organisation, their immediate families, Family Companies and Family Trusts;
      (b) a subsidiary or related corporation of the Member Organisation;
      (c) Substantial Shareholders of the Member Organisation;
   (iv) other Member Organisations; or
   (v) brokers who are members of any other Recognised Exchange.

### 3. Clients Regulated Accounts

3.3 In this Regulation:
   (i) a reference to a Client in relation to a Member Organisation means a person on behalf of whom the Member Organisation deals, or from whom the Member Organisation accepts instructions, to deal in index Contracts, but does not include:
      (a) the Member Organisation;
      (b) a person who is associated with the Member Organisation;
      (c) an employee of the Member Organisation; or
      (d) in the case of a Member Organisation:
         1. a director, or an officer, of the Member Organisation; or
         2. a body corporate that is related to the Member Organisation
   (ii) Credit Facility means a document evidencing the right of a person to obtain money on credit from another person and, without limiting the generality of the foregoing, includes a letter of credit and a bank guarantee;
   (iii) Property includes credit facilities and securities;
   (iv) Relevant Credit Balance, in relation to a Client of a Member Organisation means the total of:
      (a) the amounts deposited by the Member Organisation in respect of the Client in a Client's Segregated Account(s) of the Member Organisation less so much of those amounts as has been withdrawn from the account(s); and
      (b) the values of the items of property that:
         1. have, in respect of the Client, been deposited by the Member Organisation in safe custody pursuant to the Regulations;
         2. have not been withdrawn from safe custody; and
         3. under the terms and conditions on which they were deposited with, or received by, the Member Organisation, are available to meet, or to provide security in connection with the meeting of, relevant liabilities of the Client;
         AND for the purposes of this definition the value of an item of property at a particular time is, in the case of a credit facility, the amount of money that the person entitled to the right evidenced by the credit facility can, at that time or within a reasonable period after that time, obtain by virtue of that right or, in any other case, the market value of the property as at the end of the last Business Day before that time;
         4. Relevant Instructions and Dealings means dealings in index Contracts effected or proposed to be effected, by a Member Organisation on behalf of a Client or instructions by a Client to deal in index Contracts; and
         5. Relevant Liabilities, in relation to a Client of a Member Organisation, means liabilities of the Client arising out of dealings in index Contracts effected by the Member Organisation on behalf of the Client.
3.4 A Member Organisation shall deposit in a Client's Segregated Account:
   (i) money deposited with a Member Organisation by a Client or received by the Member Organisation for, or on behalf of, a Client in connection with relevant instructions and dealings on or before the next day the money is received by the Member Organisation that is a day on which the money may be so deposited;
   (ii) money received by the Member Organisation from the clearing House or any other person some or all of which is attributable to dealings in index Contracts effected by the Member Organisation on behalf of Clients, on the next day on which the money may be so deposited.
3.5 A Member Organisation shall deposit in safe custody property deposited with the Member Organisation by a Client or received by the Member Organisation for, or on behalf of, a Client in connection with relevant instructions and dealings on or before the next day after such property is deposited with or received by the Member Organisation that is a day on which the property may be deposited. The property shall be deposited in such manner that it is segregated from all other property held by the Member Organisation and otherwise in accordance with the terms and conditions agreed to with the Client.
3.6 Where, at a particular time, the total amount of the relevant liabilities of a Client of a Member Organisation exceeds the relevant credit balance of the Client and an amount of money or property of such value so as to cover the amount of the excess is not received by the Member Organisation within four business days of that particular time, the Member Organisation shall forthwith and by no later than the next succeeding business day in respect of the Client, deposit in a Client's Segregated Account of the Member Organisation an amount of money not greater than the amount of the excess, and the amount so deposited shall, subject to the Regulations, be deemed to be money to which the Client is entitled.
3.7 Where a Member Organisation deposits an amount pursuant to the Regulations, (the deposited amount) in a Client's Segregated Account of the Member Organisation in respect of a Client and the relevant credit balance of the Client exceeds by a particular amount (the excess amount) the total amount of the relevant liabilities of the Client, the Member Organisation may withdraw from the account so much of the deposited amount as does not exceed the excess amount.
3.8 Subject to the Regulations, where a Member Organisation deposits money in respect of a Client in a Client's Segregated Account of the Member Organisation pursuant to the Regulations, the Member Organisation shall not withdraw any of the money except for the purpose of:
   (i) making a payment to, or in accordance with the written direction of, a person entitled to the money;
   (ii) making a payment for, or in connection with, the entering into, margining, guaranteeing, securing, transferring, adjusting or settling dealings in index Contracts affected by the Member Organisation on behalf of the Client;
   (iii) defraying brokerage and other proper charges incurred in respect of dealings in index Contracts effected by the Member Organisation on behalf of the Client
   (iv) investing it:
      (a) in any manner in which trustees are for the time being authorised by law to invest trust funds;
      (b) on deposit with the Clearing House or with a corporation that is declared, pursuant to any applicable Code stipulated by the Regulations, to be an authorised dealer in the short term money market;
      (c) on deposit at interest with a banking corporation; or
      (d) in any other manner authorised by the Regulations or any applicable Code;
   (v) paying to the Member Organisation the amount of a fee that the Member Organisation may charge or an amount to which the Member Organisation is entitled under an agreement with the Client;
   (vi) making a payment that is otherwise authorised by law.
3.9 A Member Organisation shall account for money received by or according to the Member Organisation in connection with profits on Index Contracts of a Client as property of the Client provided that the Member Organisation may credit such money to Clients' Segregated Account kept by the Member Organisation and pay out such money in accordance with such Client's entitlement upon Closing Out of the Client's index Contracts.

### Annexure 2

### Sample Schedule of Fees

The patentee shall be entitled to a continuing share of fees payable by parties to SMPICs transactions or otherwise related to SMPICs transactions, the quantum of which will be established by agreement with foregoing collaborators but shall in any event be not less than eighty cents Australian ($A 0.80) per trade.

A schedule of fees payable by parties to transactions in SMPICs shall, from time, be published by the Clearing House. Except where specified to the contrary, the fees will be levied on both sides of a transaction (payable by buyers and sellers) and will include:

a) Transaction fees: A transaction fee, determined by the Clearing House and a Recognised Exchange jointly, shall be levied on each Index Unit which is the subject of a transaction. Transaction fee income will be for the account of the approved Exchange on which transactions are effected. The purpose of this fee is to provide income to Exchanges where SMPICs are traded. It is recommended that the fee be an amount approximately equivalent to a clearing fee.
b) Clearing fees: The Clearing House will determine the level of fees it will charge for its services. Clearing fees will be levied on each Index Unit which is the subject of a transaction and shall be to the account of the Clearing House.
c) Endorsement fees: The Clearing House shall determine the level of fees charged in return for their undertaking to guarantee performance of Members' obligations. Endorsement fees shall be levied on each Index Unit which is the subject of a SMPIC, but will not be levied on closing transactions.
d) Other fees: Any other fees related to the transaction

### Annexure 3

### Sample Rules Applicable to all Classes of Contract Listed on an Exchange

The terms defined in these sample Rules (Annexure 3) apply only to this Annexure and not to the patent specifications as a whole.

### 1. Listing and Terms of Contracts

(a) An Exchange may, from time to time and in its absolute discretion, list a class of contracts for trading on the Exchange with the terms of each contract comprising:
   (i) the individual contract specifications for the particular class of contract;
   (ii) the applicable generic rules set out in these rules (the Operating Rules);
   (iii) any other rule which provides that it constitutes a term of a contract; and
   (iv) the generic provisions set out in these Operating Rules for the making of determinations by the Exchange.
(b) A class of contracts listed by an Exchange may comprise contracts which have as their “contract unit” such number and class of securities as is determined by the Exchange in a company determined by the Exchange. Notwithstanding that the contract units of such contracts may differ in terms of:
   (i) the number of securities;
   (ii) the class of securities; or
   (iii) the company issuing the securities.
   If all other individual contract specifications are the same, such Contracts shall comprise a single class of contracts.
(c) If there is a conflict between a provision of the individual contract specifications and another provision of the Operating Rules, the provision of the individual contract specifications shall prevail.
(d) Each contract within a class of contracts which is listed shall be traded in accordance with the Operating Rules.

### 2. Delisting of Classes of Contracts

(a) (i) An Exchange may, from time to time and in its absolute discretion, delist any class of contracts from those listed for trading on the Exchange.
   (ii) If there are no Open Positions in the relevant class of contract which the Exchange wishes to delist, any delisting shall become effective at such time as the Exchange shall determine.
   (iii) If there are Open Positions in the relevant class of contract which the Exchange wishes to delist, trading shall be permitted only to enable the Closing Out of those Open Positions, except to the extent that the Exchange deems such trading to be necessary for the maintenance of a fair, orderly and transparent market.
(b) (i) The Exchange may from lime to time and in its absolute discretion withdraw a class of securities which it has determined for the purposes of a contract unit of a contract within the class of contracts described in paragraph 1(b) above, with the result that trading in contracts with that contract unit shall cease.
   (ii) If there are no Open Positions in the contracts referred to in paragraph (b)(i) above, the class of securities may be withdrawn at such time as the Exchange shall determine.
   (iii) If there are Open Positions in the contracts referred to in paragraph (b)(i), trading shall be permitted only to enable the Closing Out of those Open Positions, except to the extent that the Exchange deems such trading to be necessary for the maintenance of a fair, orderly and transparent market.
   (iv) A withdrawal of a class of securities shall not affect trading in contracts in the same class of contracts which have as their contract unit a class of securities which is not withdrawn.

### 3. Publication of Decisions, Prescriptions, Determinations

Where these Operating Rules or the individual contract specifications give the Exchange or Clearing House the power to make prescriptions or determinations (or decisions described in like terms) and to publish them or record them in a document, failure to so publish or record them shall not invalidate the prescription, determination or decision.

### 4. Trading Hours

The Exchange shall determine trading hours for all classes of contracts.

### Sample Rules Applicable to all Classes of Futures Contracts Listed on an Exchange

1. Effect of Futures Contracts which are Cash Settled
The effect of a futures contract which is cash settled is that the parties will make an adjustment between them at a specified future time (“the Settlement Day”) according to whether the value of the contract on the Settlement Day (“the Settlement Value”) is greater or less than the value of the futures contract at the time of the making of the futures contract (“the Contract Value”).
On the Settlement Day of a futures contract which is cash settled:
(a) the obligations of the parties to each futures contract are as follows:
   (i) if the Contract Value is less than the Settlement Value the seller shall be liable to pay the difference between that Contract Value and the Settlement Value;
   (ii) if the Contract Value is greater than the Settlement Value the buyer shall be liable to pay the difference between that Contract Value and the Settlement Value;
(b) the rights of the parties to each futures contract are as follows:
   (i) if the Contract Value is less than the Settlement Value the buyer shall be entitled to receive the difference between that Contract Value and the Settlement Value;
   (ii) if the Contract Value is greater than the Settlement Value the seller shall be entitled to receive the difference between that Contract Value and the Settlement Value;
(c) the rights and obligations of the parties to each contract shall be satisfied by cash settlement in the following way:
   (i) Sellers shall, by no later than the time determined by the Clearing House on that day, pay to or receive from the Clearing House (whichever is applicable), the amount representing the difference between the Contract Value and the Settlement Value;
   (ii) Buyers shall, by no later than the time determined by the Clearing House on that day, pay to or receive from the Clearing House (whichever is applicable), the amount representing the difference between the Contract Value and the Settlement Value.
      2. Effect of Futures Contracts which are Deliverable and Obligations of Buyers and Sellers
The effect of a futures contract which is deliverable is that the seller will deliver and the buyer will accept the commodity or thing which is the subject of the futures contract, as agreed between the parties and in accordance with the individual contract specifications for that futures contract

### 3. Provision for Making Determinations Relating to Futures Contracts

The following are terms of every class of contract that is a futures contract in addition to any other terms:

| | | |
|---|---|---|
| (a) | Manner of quoting futures | The applicable Index to four decimal |
| | prices | points |
| (b) | Minimum fluctuations to be | The fourth decimal point of the |
| | used in quoting futures | applicable Index |
| | prices | |
| (c) | Final Trading Day in a | The seventeenth day of the settlement |
| | Settlement Month | month or, if that is a non business |
| | | day, the next business day thereafter |
| (d) | Time at which trading | Such time as is determined by the |
| | ceases on Final Trading | Exchange |
| | Day | |
| (e) | Settlement Day | The business day following the Final |
| | | Trading Day |
| (f) | Final time by which seller's | Such times, respectively, on the |
| | and buyer's obligations, | Settlement Day as the Exchange |
| | respectively, must be | determines |
| | satisfied on Settlement Day | |
| (g) | Settlement Months | March, June September and December |
| (h) | Settlement Price | The applicable Index, announced on |
| | | the Final Trading Day, multiplied by |
| | | an amount to be determined and |
| | | expressed in a currency to be |
| | | determined |
| (i) | Time of declaration of | Such time as is determined by the |
| | Settlement Price | Clearing House |

### 4. Default

(a) A buyer or seller who does not settle a cash settled futures contract with the Clearing House as required by these Operating Rules shall be in default.
(b) (i) a seller of a deliverable futures contract who does not give delivery as required by these Operating Rules; and
   (ii) a buyer of a deliverable futures contract who does not take delivery as required by these Operating Rules shall be in default.
(c) In the event of default at settlement of a cash settled futures contract on the part of a participant's Client, the participant shall, unless the participant is in default under paragraph 1(c) above, have the right of Closing Out any transaction entered into in any market by such participant on behalf of the Client, without further notice and without in any way prejudicing any other legal action for recovery which the participant may take or have taken.
(d) In the event of default at settlement of a deliverable futures contract, the rights of a participant whose Client is in default shall be as specified in the relevant individual contract specifications.

### 5. Documents

Documents must be taken up and given to Clearing House participants without prejudice to and regardless of any question in dispute and such questions shall be resolved between the parties. All differences, interest and other charges are for prompt settlement.

### 6. Determination of Settlement Price

(a) The Settlement Price for each class of contract shall be determined in accordance with the relevant procedures set out in the relevant individual contract specifications. The Settlement Price so determined shall, subject to the Rules, be accepted as final.
(b) Where the individual contract specifications provide for the Settlement Price of a class of contract to be determined having regard to quotations provided by participants in the underlying market, for each relevant futures contract:
   (i) the Exchange shall determine a list of active participants in the underlying Market, to be known as the “Settlement List” for the relevant class of contract, and may amend the list from time to time. In approving parties for addition or deletion the Exchange will have regard to the extent of their participation in the market for the underlying securities in the relevant class of contract;
   (ii) the Exchange shall determine the day or days on which and the times at which quotations will be obtained to be used in the calculation of the Settlement Price;
   (iii) on the day or days determined by the Exchange, the Clearing House will request buying and selling quotes from the parties on the Settlement List. Quotations shall be sought from not less than 80 percent (or other percentage as specified in the Regulations or Operating Rules) of the members on the Settlement List (the members to be randomly selected). All quotations must be confirmed to the Clearing House in writing;
   (iv) where a person representing a selected name fails to declare buying and selling quotations, or the spread between the buying and selling quotations is greater than 0.10 percent per annum or the nearest practical equivalent of 0.10 percent per annum (or other percentage specified in the Regulations or Operating Rules) where quotations are provided in other than yield percent per annum, then each quotation submitted on behalf of that name for each quotation time shall not be accepted;
   (v) requirements relating to the quotations sought and procedures for calculation shall be set out in the individual contract specifications for each relevant class of contract.

### 7. Appointment of Clearing House as Agent and Attorney

Without prejudice to any other provisions in these Operating Rules:
(a) each participant who is a party to a deliverable futures contract irrevocably appoints the Clearing House as its agent and attorney to perform all acts on its behalf, and to exercise all powers necessary to effect delivery of the futures contract, together with all powers which are reasonably incidental to those acts and powers;
(b) the Clearing House may perform any of its duties or obligations under these Rules by or through its officers, employees or agents; and
(c) each Clearing House participant will indemnify the Clearing House and keep the Clearing House indemnified against any loss or claim arising from the Clearing House's performance of its obligations in relation to any safe accommodation service.

### 8. Warehouse Receipts

(a) This Rule applies in respect of warehouse receipts which are issued in respect of a class of contract which is listed on the Exchange.
(b) In this Rule, “warehouse receipt” includes a warehouse receipt which is forged or which contains any endorsement or signature which is forged, irregular, or which has been placed on the warehouse receipt without the authority of the person whose signature it purports to be.
(c) None of the Exchange, the Clearing House, their respective boards, Directors and employees will be liable in respect of, or in connection with:
   (i) the delivery of a warehouse receipt;
   (ii) the transfer of title, or failure to transfer title, of a commodity by an approved warehouse in respect of a warehouse receipt;
   (iii) the limitation or exclusion of liability by an approved warehouse in respect of a warehouse receipt
(d) The Exchange, the Clearing House and approved warehouses intend that the rights represented by a warehouse receipt may be transferred by the endorsement and delivery of that warehouse receipt by the holder, and that warehouse receipts will be used by all market participants on that basis. However, the approved warehouse, in issuing the warehouse receipt does not warrant the negotiability of the warehouse receipt, and neither the Clearing House nor the Exchange warrant the negotiability of a warehouse receipt. No right of action can be acquired by any person (including the holder of a warehouse receipt) against an approved warehouse, the Clearing House or the Exchange by reason only of a warehouse receipt being in fact not negotiable.
(e) Provided that the seller has acted in good faith and in the ordinary course of business:
   (i) the delivery to a buyer or the Clearing House of an endorsed warehouse receipt and certificates as required by these Operating Rules or the Operating Rules of the Clearing House in respect of a futures contract shall fully discharge the obligations of the seller;
   (ii) the seller is not required to prove that the endorsements (if any) are regular and were made by or under the authority of the persons whose endorsement they purport to be; and
   (iii) the buyer has no right of action against the seller of the warehouse receipt even if it contains any endorsement or signature which is forged, irregular, or which has been placed on the warehouse receipt without the authority of the person whose signature it purports to be.
(f) The buyer agrees with the Clearing House, the Exchange and Clearing House participants that the buyer has no right of action against any holder or previous holder of the warehouse receipt even if it contains endorsements which are irregular, unauthorised or forged provided that the holder was a bona fide purchaser without notice. These Operating Rules constitute an effective release of liability that such a holder would but for this Rule otherwise be under.

### Sample Rules Applicable to all Classes of Option Contract Listed on an Exchange

### 1. General

Option contracts may be:
(a) option contracts over futures contracts or option contracts over an underlying physical, which in both cases shall expire on the declaration date determined by the Exchange; and
(b) Call options or put options; and
(c) deliverable or cash settled.

### 2. Effect of Option Contract

(a) Deliverable call option contracts over a futures contract
   In the case of deliverable call option contracts over a futures contract:
   (i) the buyer (taker) of the option contract acquires the right to a bought futures position in the underlying futures contract specified in the contract unit in the individual contract specifications in consideration for a contract premium; and
   (ii) in the event that the buyer of the option contract exercises that right, a seller (grantor) as appointed by the Clearing House in accordance with the clearing rules shall be vested with a sold futures position in the underlying futures contract at the same price and in the same Settlement Month as that assumed by the buyer of the option contract; and
   (iii) the buyer acquires the right to a bought futures position at an exercise price agreed between the parties, provided it is selected from a list of such prices determined under the relevant individual contract specifications; and
   (iv) where an option contract over a futures contract is exercised, the resulting futures contract shall be registered at the exercise price agreed pursuant to paragraph 2(a)(iii) above.
(b) Deliverable put option contracts over a futures contract
   In the case of deliverable put option contracts over a futures contract:
   (i) the buyer (taker) of the option contract acquires the right to a sold futures position in the Underlying futures contract specified in the Contract Unit in the individual contract specifications in consideration for a contract premium; and
   (ii) in the event that the buyer of the option contract exercises that right, a seller (grantor) as appointed by the Clearing House in accordance with the clearing rules shall be vested with a bought futures position in the underlying futures contract at the same price and in the same Settlement Month as that assumed by the buyer of the option contract; and
   (iii) the buyer acquires the right to a sold futures position at an exercise price agreed between the parties, provided that it is selected from a list of such prices determined under the relevant individual contract specifications; and
   (iv) where an option contract over a futures contract is exercised, the resulting futures contract shall be registered at the exercise price agreed pursuant to paragraph 2(b)(iii) above.
(c) Deliverable strip option contracts which are call option contracts
   In the case of deliverable strip options contracts which are call option contracts:
   (i) the buyer (taker) of the strip option contract acquires the right to bought positions in the underlying futures contracts specified in the Contract Unit in the individual contract specifications, in consideration for a contract premium; and
   (ii) in the event that the buyer of the strip option contract exercises that right, a seller (grantor) as appointed by the Clearing House in accordance with the clearing rules shall be vested with sold futures positions in the underlying futures contracts, at the same prices and in the same Settlement Months as those assumed by the buyer of the strip option contract; and
   (iii) the buyer acquires the right referred to in paragraph 2(c)(i) above at an exercise price agreed between the parties, provided it is selected from a list of such prices as shall be determined under the relevant individual contract specifications; and
   (iv) where a strip option contract is exercised, the resulting futures contracts shall be registered at such prices as shall be determined under the relevant individual contract specifications.
(d) Deliverable strip option contracts which are put option contracts
   In the case of deliverable strip options which are put option contracts:
   (i) the buyer (taker) of the strip option contract acquires the right to sold positions in the underlying futures contracts specified in the Contract Unit in the individual contract specifications in consideration for a contract premium; and
   (ii) in the event that the buyer of the strip option contract exercises that right, a seller (grantor) as appointed by the Clearing House in accordance with the clearing rules shall be vested with bought futures positions in the underlying futures contracts at the same prices and in the same Settlement Months as those assumed by the buyer of the strip option contract; and
   (iii) the buyer acquires the right referred to in paragraph 2(d)(i) at an exercise price agreed between the parties, provided that it is selected from a list of such prices as shall be determined under the relevant individual contract specifications; and
   (iv) where a strip option contract is exercised, the resulting futures contracts shall be registered at such prices as shall be determined under the relevant individual contract specifications.
(e) Deliverable call option contracts over an underlying physical
   In the case of deliverable call option contracts over an underlying physical:
   (i) the buyer (taker) of the option contract acquires the right to buy the amount of the underlying physical specified in the Contract Unit in the individual contract specifications in consideration for a contract premium; and
   (ii) in the event that the buyer of the option contract exercises that right, a seller (grantor) as appointed by the Clearing House in accordance with the clearing rules assumes the obligations to sell the amount of the underlying physical referred to in paragraph 2(e)(i) to the buyer; and
   (iii) the buyer acquires the right referred to in paragraph 2(e)(i) to buy the underlying physical at an exercise price agreed between the parties provided it is selected from a list of such prices determined under the relevant individual contract specifications.
(f) Deliverable put option contracts over an underlying physical
   In the case of deliverable put option contracts over an underlying physical:
   (i) the buyer (taker) of the option contract acquires the right to sell the amount of the underlying physical specified in the Contract Unit in the individual contract specifications in consideration for a contract premium; and
   (ii) in the event that the buyer of the option contract exercises that right, a seller (grantor) as appointed by the Clearing House in accordance with the clearing rules assumes the obligations to buy the amount of the underlying physical referred to in paragraph 2(f)(i) from the buyer; and
   (iii) the buyer acquires the right referred to in paragraph 2(f)(i) to sell the underlying physical at an exercise price agreed between the parties provided that it is selected from a list of such prices determined under the relevant individual contract specifications.
(g) Cash settled call option contracts
   In the case of cash settled call option contracts:
   (i) the buyer (taker) of the option contract acquires the right to payment of an amount equivalent to the difference between the exercise price of the option and the Settlement Price in consideration for a contract premium if the Settlement Price is higher than the exercise price; and
   (ii) in the event that the buyer of the option contract exercises that right, a seller (grantor) as appointed by the Clearing House in accordance with the clearing rules assumes the obligation to pay the amount referred to in paragraph 2(g)(i) to the buyer.
(h) Cash settled put option contracts
   In the case of cash settled put option contracts:
   (i) the buyer (taker) of the option contract acquires the right to payment of an amount equivalent to the difference between the exercise price of the option and the Settlement Price in consideration for a contract premium if the Settlement Price is lower than the exercise price; and
   (ii) in the event that the buyer of the option contract exercises that right, a seller (grantor) as appointed by the Clearing House in accordance with the clearing rules assumes the obligation to pay the amount referred to in paragraph 2(h)(i) to the buyer.

### 3. Rights of Buyer

(a) Rights of buyer of all option contracts
   The buyer of an option contract may, prior to the expiration of trading on the declaration date, sell an option contract of the same type at the same exercise price and with the same Settlement Month as that option contract bought, in which case the bought and sold positions may be Closed Out.
(b) Rights of buyer of deliverable ordinary, serial and strip option contracts over a futures contract
   (i) The buyer of a deliverable ordinary, serial and strip option contract may exercise the option at any time prior to the time determined by the Exchange for lodging exercise requests in the relevant option contract, in which case the buyer shall:
      (A) in the case of a ordinary or serial option, become the holder of a bought futures position (in the case of a Call option contract), or the holder of a sold futures position (in the case of a pat option contract), in the underlying futures contract in the same month and at the same price as the option contract bought; or
      (B) in the case of a strip option, become the holder of bought futures positions (in the case of a Call option contract), or the holder of sold futures positions (in the case of a put option contract), in the underlying futures contracts in the same months, at the prices determined in accordance with the individual contract specifications; or
   (ii) allow the Clearing House, on the declaration date, to automatically exercise the option contract or let it lapse, in accordance with the relevant individual contract specifications; or
   (iii) prevent the automatic exercise of the option by lodging a “deny automatic exercise request” within the exchange “allocation & clearing system” at any time prior to the time determined by the Exchange for lodging a “deny automatic exercise request” in the relevant contract, in which case the option contract shall be deemed to have lapsed.
(c) Rights of buyer of deliverable option contracts over an underlying physical
   The buyer of a deliverable option contract over an underlying physical may:
   (i) exercise the option at any time prior to the time determined by the Exchange for lodging “exercise requests” in the relevant option contract, in which case the buyer shall take delivery of the underlying physical specified in the individual contract specifications (in the case of a call option contract), or sell the underlying physical specified in the individual contract specifications (in the case of a put option contract) at the exercise price referred to in paragraph 2(e)(iii) or (f)(iii), as the case may be; or
   (ii) allow the Clearing House, on the declaration date, to automatically exercise the option contract or let it lapse, in accordance with the relevant individual contract specifications; or
   (iii) prevent the automatic exercise of the option by lodging a “deny automatic exercise request” within the “exchange allocation & clearing system” at any time prior to the time determined by the Exchange for lodging a “deny automatic exercise request” in the relevant contract, in which case the option contract shall be deemed to have lapsed.
(d) No right of buyer to exercise intraday and overnight option contracts
   Neither deliverable nor cash settled intraday options and overnight options may be exercised by the buyer and are automatically exercised or allowed to lapse by the Clearing House.

### 4. Rights of Seller to Close Out for all Option Contracts Prior to Expiry

Prior to the expiration of trading on the declaration date the seller of an option contract shall be entitled to buy an option contract of the same type at the same exercise price and with the same Settlement Month as that sold in which case the bought and sold positions may be Closed Out.

### 5. Rights of Holder of Bought and Sold Options for all Option Contracts on Expiry

Where a person holds bought and sold option contracts at the same exercise price and with the same Settlement Month, the sold position may be exercised against on expiry.

### 6. Provision for Making Determinations Relating to Options Contracts

Unless otherwise specified in the individual contract specifications for a particular class of contract:
(a) The following are terms of every class of options contract, in addition to other terms:

| | | |
|---|---|---|
| (i) | Manner of quoting contract | Such manner as is determined by |
| | premiums | the Exchange |
| (ii) | Minimum fluctuations to be | Such fluctuation as is |
| | used in quoting contract | determined by the Exchange |
| | premium | |
| (iii) | Manner of quoting exercise | Such manner as is determined by |
| | prices of options | the Exchange |
| (iv) | Minimum fluctuations to be | Such fluctuation as is |
| | used in quoting exercise | determined by the Exchange |
| | prices of options | |
| (v) | Expiry months | Such months as are determined |
| | | by the Exchange |
| (vi) | Declaration date | Such business day as is |
| | | determined by the Exchange |
| (vii) | Time at which trading ceases | Such time as is determined by |
| | on declaration date | the Exchange |

(b) The following are terms of every class of contract which are ordinary options, strip options or serial options, in addition to the terms set out in (a) above, and any other terms:

| | | |
|---|---|---|
| (i) | Time by which participants | Such time or times as is |
| | must lodge request or deny | determined by the Exchange |
| | automatic exercise requests | |
| | for exercise of ordinary, | |
| | strip and serial options | |
| (ii) | The serial options price | Such price as is determined by |
| | | the Clearing House |

### Explanatory Note:

The terms of all ordinary options and serial options include the matters set out in (a) and (b) above, as well as in the individual contract specifications for ordinary options or serial options, as the case may be, and otherwise as provided in these Operating Rules.
(c) The following are terms of every class of contract which are intraday or overnight options, in addition to the terms set out in (a) above and any other terms:

| | | |
|---|---|---|
| (i) | day of contract expiry | Such business day as is |
| | | determined by the Exchange |
| (ii) | Time of contract expiry | Such time as is determined by |
| | | the Exchange |
| (iii) | the intraday options | Such price as is determined by |
| | futures price | the Clearing House |
| (iv) | The overnight options | Such price as is determined by |
| | futures price | the Clearing House |

### Explanatory Note:

The terms of all intraday options or overnight options include the matters set out in (a) and (c) above, as well as in the individual contract specifications for intraday options or overnight options, as the case may be, and otherwise as provided in these Rules.

### 7. Premium

(a) An option contract shall be entered into in consideration of a contract premium payable by the buyer.
(b) The contract premium shall be calculated in accordance with these Operating Rules and payment thereof shall be governed by the deposit and margin requirements set out in the Operating Rules.

### 8. Exercise Prices

Exercise prices shall be determined by the exchange from time to time to reflect the movement of the price of the applicable futures contract or underlying physical, and the exchange shall publish each new exercise price as it is determined.

### 9. Effect of Registration

Upon the registration of an option contract by the Clearing House, such option contract shall be replaced by a option contract or option contracts in accordance with the clearing rules and each option contract so registered shall be extinguished and the parties to such option contract shall be released from their obligations to each other.

### 10. Lodgement of Exercise or Deny Automatic Exercise Requests in Respect of Deliverable Ordinary Serial and Strip Option Contracts and Option Contracts Over an Underlying Physical

(a) Exercise of an option or prevention of the automatic exercise of an option may be carried out by lodging electronically with the Clearing House, an “exercise request and/or deny automatic exercise request” in the “exchange allocation & clearing system” or in a form determined by the Clearing House.
(b) A participant who holds a bought (Call or put) option contract on behalf of a Client may exercise or prevent the automatic exercise of the option provided that the participant has received the relevant instructions from the Client prior to the time for lodgement of the exercise and/or deny automatic exercise request.

### 11. Exercise/Expiry of all Option Contracts on Declaration Date

On the declaration date of both cash settled and deliverable option contracts, the Clearing House shall, unless otherwise directed by an “exercise request” and/or “deny automatic exercise request” in respect of an ordinary option or a serial option, or unless the relevant individual contract specifications state otherwise:
(a) exercise all in-the-money options; and
(b) allow all other option contracts to expire.
   12. Option Contracts which are in-the-Money
(a) Deliverable options
   (i) An ordinary option over a futures contract which is cash settled is in-the-money if the Settlement Price of the underlying futures contract Settlement Month lies above the exercise price in the case of a Call option contract, or lies below the exercise price in the case of a put option contract.
   (ii) An ordinary option over a futures contract which is deliverable is in-the-money if the daily Settlement Price for the underlying futures contract Settlement Month for the declaration date lies above the exercise price in the case of a call option contract, or lies below the exercise price in the case of a put option contract.
   (iii) A strip option is in-the-money if the options Settlement Price lies above the exercise price in the case of a call option contract or lies below the exercise price in the case of a put option contract. The option Settlement Price shall be determined in accordance with the individual contract specifications.
   (iv) A serial option is in-the-money if the serial option price lies above the exercise price in the case of a Call option contract or lies below the exercise price in the case of a put option contract. The serial option price shall be determined by reference to the underlying futures market price at expiry of the serial option.
   (v) An intraday option is in-the-money if the intraday, option futures price of the underlying futures contract Settlement Month lies above the exercise price in the case of a call option contract or lies below the exercise price in the case of a put option contract. Intraday option futures prices shall be determined in accordance with the price sampling procedures which are specified in the individual contract specifications for the relevant option contracts.
   (vi) An overnight option is in-the-money if the overnight option futures price of the underlying futures contract settlement month lies above the exercise price in the case of a call option contract or lies below the exercise price in the case of a put option contract. Overnight option futures prices shall be determined in accordance with the price sampling procedures which are specified in the individual contract specifications for the relevant option contracts.
   (vii) An option over an underlying physical is in-the-money if the Settlement Price of the underlying physical lies above the exercise price in the case of a Call option contract, or lies below the exercise price in the case of a put option contract.
(b) Cash settled option contracts
   A cash settled option over a futures contract or underlying physical is in-the-money if the Settlement Price lies above the Exercise Price in the case of a Call option contract or lies below the exercise price in the case of a put option contract.

### 13. Notification to Sellers

(a) Notification to sellers of deliverable option contracts over a futures contract
   (i) Upon receipt of an “exercise request”, the Clearing House will notify the seller that the seller has become:
      (A) in the case of an option over a futures contract, the holder of a sold futures position in the case of a Call option contract, or the holder of a bought futures position in the case of a put option contract, in the underlying futures contract in the same month and at the same exercise price as the option contract sold;
      (B) in the case of a strip option, the holder of sold futures positions in the case of a Call option, or the holder of bought futures positions in the case of a put option, in the underlying futures contracts in the same months and at the same exercise prices as the option contract sold;
      (C) entitled to receive the net value of the contract premium.
   (ii) On the declaration date, the seller will receive such notification after the exercise request is lodged in the “exchange allocation & clearing system” and by not later than the time determined by the Exchange for each relevant option contract.
   (iii) On all other business days, the seller will receive such notification after the conclusion of business processing at the end of the day on which the exercise request was lodged by the seller and by not later than the time determined by the Exchange for each relevant option contract.
(b) Notification to sellers of deliverable equity option contracts over an underlying physical
   (i) Upon receipt of an “exercise request”, the Clearing House will notify the seller, as soon as practicable, that the equity option over an underlying physical has been exercised.
   (ii) On the declaration date, the seller will receive the notification referred to above after the exercise request is lodged in the “exchange allocation & clearing system” and by not later that the time determined by the Exchange for each relevant option contract.
   (iii) On all other business days, the seller will receive the notification referred to above after the conclusion of business processing at the end of the day on which the exercise request was lodged by the seller and by not later that the time determined by the Exchange for each relevant option contract.
(c) Notification to sellers of cash settled option contracts
   On the declaration date, the seller will receive notification of any settlement value to be paid and the contract premium to be received by not later than the time determined by the Exchange for each relevant option contract.

### 14. Obligations of Participant on Exercise of Deliverable Option Contracts Over a Futures Contract

Where the seller has become the holder of a futures position pursuant to the exercise of an option contract, the seller shall comply with the provisions of these operating rules relating to the futures positions.

### 15. Disputes

Documents must be taken up without prejudice to any question in dispute and such question shall be agreed between the parties. All differences, interests and all other charges are for prompt settlement.

### Annexure 4

The terms defined in this Annexure apply only to this Annexure and not to the patent specifications as a whole.

### 1. Index Futures Contracts

| Item | Heading | Individual Contract Specifications |
|---|---|---|
| 1.1 | Contract unit | A sum of money equal to the applicable Index, as referred |
| | | to in these individual contract specifications, multiplied |
| | | by an amount to be determined in Australian dollars. |
| 1.2 | Type of contract | Cash settled |
| 2 | Contract value | The price agreed to by the parties at the time of making |
| | | the futures contract and multiplied by an amount to be |
| | | agreed and expressed as Australian dollars. |
| 3 | Settlement Price | The numerical value of the index quoted by the Clearing |
| | | House for the relevant Settlement Day to be the special |
| | | opening quotation of the Index provided by the Index |
| | | Vendor or its duly authorised agent by notice in writing to |
| | | the Exchange by, unless otherwise agreed by all parties, |
| | | 12.00 noon on the business day following the Final |
| | | Trading Day. |
| 4 | Settlement Value | The numerical value of the index quoted by the Clearing |
| | | House for that Settlement Day (to four decimal places) |
| | | multiplied by an amount to be determined and expressed |
| | | as Australian dollars. |
| 5 | Exclusion of | Subject to the right of the Exchange under the Rules to |
| | liability | direct that contracts be settled at a price other than that |
| | | determined in accordance with the individual contract |
| | | specifications, the Exchange and the Clearing House shall |
| | | be entitled to regard the numerical value provided by the |
| | | Index Vendor or its duly authorised agent as being |
| | | conclusive evidence of the special opening quotation. |
| | | In the event of the Index Vendor failing to provide such |
| | | quotation or providing a quotation that is numerically |
| | | inaccurate, no party shall make any claim whatsoever |
| | | against the Index Vendor, its duly authorised agents, the |
| | | Clearing House or the Exchange, and the Rules shall |
| | | apply. |
| 6 | Inability for the | If a situation is developing or has developed which is |
| | Clearing House to | capable of preventing the Clearing House from declaring |
| | declare | the Settlement Price in accordance with these individual |
| | Settlement Price | contract specifications, or if an undesirable situation |
| | and undesirable | within the meaning of the Rules is developing or has |
| | situations | developed, then the Rules shall apply and any provision |
| | | of these Operating Rules which cannot be complied with |
| | | until the price has been declared shall be complied with |
| | | as soon as possible after it has been declared. |

### Explanatory Note

The terms of all index futures contracts comprise a combination of:

(i) the individual contract specifications set out above; and
(ii) the generic specifications set out elsewhere in the Rules.

As to the generic specifications, see in particular the Rules:
(a) which provide for determinations by the Exchange as to:
   (i) the units in which prices are to be quoted by participants when submitting orders
   (ii) the Final Trading Day in a Settlement Month
   (iii) the time at which trading ceases on the Final Trading Day
   (iv) the Settlement Day
   (v) the final times by which the seller's and buyer's obligations, respectively, must be satisfied on the Settlement Day
   (vi) the Settlement Months in which a Final Trading Day for a contract occurs; and
(b) which set out the effect of the contract in terms of the obligations to pay in cash or receive in cash, respectively, the difference between the contract value and the Settlement Value.

Pursuant to the generic terms/specifications for all contracts that are set out in the Rule providing for various determinations by the Exchange, the actual determinations (which do not themselves constitute terms of the contracts) are set out, for information, in the separate document “Procedures, determinations and practice notes” (this document does not form part of the Rules).

For example, the generic term/specification in the Rules relating to the Final Trading Day for this contract day is as follows:

“Final Trading Day”—such business day as is determined by the Exchange. The actual determination made by the Exchange is “the third Thursday of the Settlement Month”.

### 2. Ordinary Options Over Index Futures Contracts

| Item | Heading | individual contract specifications |
|---|---|---|
| 1 | Contract unit | An Exchange Index futures contract |
| 2 | Undesirable | If an undesirable situation within the meaning |
| | situations | of the Rules is developing or has developed, |
| | | then the Rules shall apply and any provision of |
| | | these Operating Rules which cannot be complied |
| | | with until the value or price has been declared |
| | | shall be complied with as soon as possible after |
| | | it has been declared. |

### Explanatory Note

The terms of all ordinary options over the exchange index futures contracts comprise a combination of:

(i) the individual contract specifications set out above; and
(ii) the generic specifications set out elsewhere in the Rules.

As to the generic specifications, see in particular the Rules:
(a) which provide for determinations by the Exchange as to:
   (i) the declaration day
   (ii) Time at which trading ceases on the declaration date
   (iii) Settlement Months
   (iv) Trading dines
   (v) Mariner in which premium is quoted and minimum fluctuation
   (vi) Manner in which exercise price is quoted and minimum fluctuations
   (vii) Latest time for entering position close outs for serial options
   (viii) Latest time for lodgement of a request or a deny automatic exercise request; and
(b) which set out terms which are applicable to all option contracts.

Pursuant to the generic terms/specifications for all contracts that are set out in the Rules providing for various determinations by the Exchange, the actual determinations (which do not themselves constitute terms of the contracts) are set out, for information, in the separate document “Procedures, Determinations and Practice Notes” (this document does not form part of the Rules).

For example, the generic term/specification in the Rules relating to the time on which trading in options ceases is as follows:

“Time at which trading ceases:”—such time as is determined by the Exchange; the actual determination made by the Exchange pursuant to this power is “12.00 noon on the declaration date.

1. A financial mechanism to enable creation of a spot market for trading of one or more indices on a Recognised Exchange including:
a) a fungible instrument defined as a Spot Market Price Index Contract (SMPIC); and
b) listing of said SMPIC in said spot market on at least one Recognised Exchange; and
c) software, hardware and computer implemented systems to enable said creation.

2. A financial mechanism according to claim 1 to enable creation of a derivative market for trading of one or more indices on a Recognised Exchange including:
a) said SMPIC; and
b) listing of said SMPIC in said derivative market on at least one Recognised Exchange.

3. A financial mechanism according to claim 1 wherein said SMPIC is an instrument for trading an index on a Recognised Exchange.

4. A financial mechanism according to claim 1 wherein said SMPIC is an undertaking from a seller to pay a Redemption Value of an underlying index to a buyer On Demand.

5. A financial mechanism for listing an index on a Recognised Exchange for spot market trading, wherein said index may be one of the following, without limitation:
a) a consumer price index;
b) a producer price index;
c) a primary production price index;
d) a manufacturing price index;
e) a currency index;
f) a housing price index;
g) a commodity price index such as an index for:
(i) energy;
(ii) a foodstuff;
(iii) a metal;
(iv) a mineral;
(v) a textile;
(vi) livestock;
(vii) water;
h) a weather index;
i) an interest rates index;
j) a carbon index; or
k) any other economic indicator; and
l) software, hardware and computer implemented systems to enable the listing of said index.

6. A financial mechanism for listing an index on a Recognised Exchange for derivative market trading, wherein said index may be one of the following, without limitation:
a) a consumer price index;
b) a producer price index;
c) a primary production price index;
d) a manufacturing price index;
e) a currency index;
f) a housing price index;
g) a commodity price index such as an index for:
(i) energy;
(ii) a foodstuff;
(iii) a metal;
(iv) a mineral;
(v) a textile;
(vi) livestock;
(vii) water;
h) a weather index;
i) an interest rates index;
j) a carbon index; or
k) any other economic indicator; and
l) software, hardware and computer implemented systems to enable the listing of said index.

7. A financial mechanism according to claim 5 for spot market trading of an index on a Recognised Exchange, wherein said index may be one of the following, without limitation:
a) a consumer price index;
b) a producer price index;
c) a primary production price index;
d) a manufacturing price index;
e) a currency index;
f) a housing price index;
g) a commodity price index such as an index for:
(i) energy;
(ii) a foodstuff;
(iii) a metal;
(iv) a mineral;
(v) a textile;
(vi) livestock;
(vii) water;
h) a weather index;
i) an interest rates index;
j) a carbon index; or
k) any other economic indicator.

8. A financial mechanism according to claim 5 for derivative market trading of an index on a Recognised Exchange, wherein said index may be one of the following, without limitation:
a) a consumer price index;
b) a producer price index;
c) a primary production price index;
d) a manufacturing price index;
e) a currency index;
f) a housing price index;
g) a commodity price index such as an index for:
(i) energy;
(ii) a foodstuff;
(iii) a metal;
(iv) a mineral;
(v) a textile;
(vi) livestock;
(vii) water;
h) a weather index;
i) an interest rates index;
j) a carbon index; or
k) any other economic indicator.

9. A financial mechanism according to claim 1 wherein said SMPIC is an instrument for trading a Price Index.

10. A financial mechanism according to claim 1 wherein said SMPIC is an instrument for trading a Non-Revisionary Index.

11. A financial mechanism according to claim 1 wherein said SMPIC is a multi-originator single instrument for publicly trading an index.

12. A financial mechanism according to claim 1 for trading said index on said Recognised Exchange, wherein said trading involves a sale of said SMPIC.

13. A financial mechanism according to claim 12 wherein said trading of a SMPIC on a Recognised Exchange enables public trading of the value of an index, said Index being accepted as a reliable measure of a specific commodity, asset or industry performance.

14. A financial mechanism according to claim 1 wherein said SMPIC:
a) enables both primary issue of index-based trading and secondary trading in an index-based derivative; and
b) facilitates the introduction of one or more Spot Markets based on one or more said indices together with their associated derivative markets.

15. A financial mechanism according to claim 1, wherein said SMPIC is issued by an Authorised Originator who:
a) receives A financial proceeds for a sold position in relation to said SMPIC;
b) is “marked to market”; and
c) lodges acceptable security to cover any contractual obligations and adverse margins.

16. A financial mechanism according to claim 1 wherein a price at which said SMPIC is traded:
a) reflects a current value of said index; and
b) is agreed between a buyer and a seller in accordance with regulations of said Recognised Exchange.

17. financial mechanism according to claim 1 wherein a buyer of said SMPIC (other than a Market Maker) pays full settlement price of said SMPIC to a seller according to said Recognised Exchange regulations and can then elect to:
a) hold said SMPIC;
b) sell said SMPIC in the market (on a Recognised Exchange); or
c) present said SMPIC back to said seller (via a Clearing House) for redemption.

18. A financial mechanism according to claim 4 wherein said buyer who elects to sell said SMPIC in the market (on a Recognised Exchange):
a) surrenders said SMPIC for cancellation; and
b) receives said full settlement price of said sold SMPIC.

19. A financial mechanism according claim 4 where:
a) a register of said SMPICs is maintained, said register including names of parties to a transaction and said settlement price; and
b) said names of parties may be substituted by novation.

20. A financial mechanism according to claim 14 wherein said Authorised Originator of said SMPIC, which has first been issued, lodged with and endorsed by said Clearing House and is subsequently sold, is entitled to receive full settlement price of such said SMPIC, less an amount held by said Clearing House as a security deposit to cover said Authorised Originator's obligations to perform in accordance with said regulations.

21.-135. (canceled)
